(19) United States
(12) Patent Application Publication
(10) Pub. No.: US 2026/0289649 A1
(43) Pub. Date: Sep. 24, 2026

(54) SYSTEM

(71) Applicant: SoftBank Group Corp., Tokyo (JP)

(72) Inventor: Soshi KOYAMA, Tokyo (JP)

(73) Assignee: SoftBank Group Corp., Tokyo (JP)

(21) Appl. No.: 19/568,888

(22) Filed: Mar. 17, 2026

(30) Foreign Application Priority Data
Mar. 19, 2025 (JP) 2025-045188

(51) Int. Cl. G06Q 30/0601

(52) U.S. Cl. CPC G06Q 30/0633

(57) ABSTRACT

A system includes a processor that is configured to parse product information input by a user, select an appropriate listing template based on the parsed product information, and automatically generate a listing page based on the product information by using one or more prompts that instruct the processor to input the product information and to automatically generate the listing page based on the product information; generate an automatic response for semi-automatic communication with a purchaser by using one or more prompts that instruct the processor to allow a seller to set a desired price and to perform the semi-automatic communication with the purchaser; and analyze review content and present specific improvement items for semi-automatic execution of shipping operations and for proposing product improvements and price revisions based on reviews by using one or more prompts that instruct the processor to perform analysis of the review content.

### CROSS-REFERENCE TO RELATED APPLICATION

This application is based on and claims priority under 35 USC 119 from Japanese Patent Application No. 2025-045188 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional online listing systems require a seller to manually input detailed product information, construct a listing page layout, and repeatedly perform communication and shipping-related tasks. In particular, when only minimal product information such as a product code is available, the seller is still required to manually determine an appropriate page structure, write descriptive text, and set pricing. Furthermore, conventional systems generally provide only basic messaging functions between sellers and purchasers, and do not support semi-automatic generation of responses tailored to the context of a transaction. Shipping operations are also largely manual, and the system does not utilize accumulated review information to provide concrete guidance for improving product offerings or revising prices. As a result, the workload on sellers remains high, the quality and consistency of listing pages and responses can vary significantly, and opportunities to systematically improve products and pricing based on user feedback are not fully realized. In addition, existing systems rarely incorporate emotion analysis of user text to refine improvement proposals or pricing strategies.

### SUMMARY

To solve the above-described problems, a system is provided that comprises a processor configured to perform a series of coordinated operations using prompts as instructions for automated and semi-automated processing. The processor is configured to parse product information input by a user, select an appropriate listing template based on the parsed product information, and automatically generate a listing page based on the product information by using one or more prompts that instruct the processor to input the product information and to automatically generate the listing page based on the product information. The processor is further configured to generate an automatic response for semi-automatic communication with a purchaser by using one or more prompts that instruct the processor to allow a seller to set a desired price and to perform semi-automatic communication with the purchaser. In addition, the processor is configured to analyze review content and present specific improvement items for semi-automatic execution of shipping operations and for proposing product improvements and price revisions based on reviews by using one or more prompts that instruct the processor to perform analysis of the review content and to present the specific improvement items. In certain embodiments, the processor is configured to analyze text data of a user and evaluate an emotional state of the user by using an emotion engine, and to use one or more prompts that instruct the processor to recognize the emotional state of the user and to make proposals for product improvements and price revisions based on the emotional state. In further embodiments, the processor is configured to parse product information registered by a user, select an appropriate template based on the parsed product information, and construct a listing page by using one or more prompts that instruct the processor to automatically generate the listing page using only the registered product information.

The term “processor” refers to a hardware or virtual computing element, such as a CPU, GPU, microcontroller, or a combination thereof, and may also encompass multiple processors or processing cores operating together to execute instructions and perform the functions described in the claims.

The term “product information” refers to any data that identifies or describes a product, including but not limited to product codes, JAN codes, titles, names, authors, publishers, release dates, categories, specifications, and user-entered descriptions.

The term “prompt” refers to information, an instruction, or a directive, including a natural-language expression, rule, or template, that is provided to the processor in order to cause the processor to execute a specific operation or sequence of operations such as parsing, generating, or analyzing data.

The term “listing page” refers to an electronically generated page or screen that presents information about a product for sale, including at least product information and price information, and that is displayable to users via a networked device.

The term “template” refers to a predefined data structure, layout definition, or format, including fields or placeholders, that is used by the processor as a basis for constructing or generating a listing page.

The term “automatic response” refers to a message or content that is generated, at least in part, by the processor without requiring the user to compose the entire message manually, based on prompts, stored data, or contextual information.

The term “semi-automatic communication” refers to an interaction in which the processor generates or suggests part or all of the communication content, while allowing a user to review, modify, supplement, or approve the communication before it is transmitted.

The term “shipping operations” refers to processing related to the fulfillment of an order, including at least preparation of shipping information, generation of shipping labels or instructions, management of shipping status, and communication of shipping details to relevant users.

The term “review” refers to feedback information submitted by a user in connection with a product or transaction, including at least a rating, a textual comment, or both, and optionally including metadata such as date, time, and user identification.

The term “review content” refers to the substantive portion of a review, including textual comments, ratings, and any other evaluative information that can be analyzed to assess user satisfaction, product quality, or price suitability.

The term “product improvement” refers to any modification or enhancement related to a product, its presentation, or its associated services, including changes in product quality, packaging, description, associated images, or other characteristics intended to increase user satisfaction.

The term “price revision” refers to a modification of a selling price of a product, including increasing or decreasing the price or changing related pricing conditions such as discounts or bundled offers.

The term “emotion engine” refers to a software module, hardware module, or combination thereof that analyzes user text data or related signals to estimate, classify, or otherwise evaluate an emotional state of the user.

The term “emotional state” refers to a state or tendency associated with user emotions, such as satisfaction, dissatisfaction, anger, joy, frustration, or neutrality, as inferred from text data or other user-provided information.

The term “text data of a user” refers to any textual input provided by a user, including but not limited to reviews, inquiries, messages, comments, and responses, that can be processed by the processor for analysis or generation tasks.

The term “registered product information” refers to product information that has been previously stored or recorded in a database or storage associated with the system, as opposed to transient or purely real-time input.

The term “analyze” refers to processing data by the processor to extract structure, meaning, features, metrics, or patterns, including operations such as parsing, classification, keyword extraction, sentiment evaluation, and statistical computation.

The term “specific improvement items” refers to concrete, actionable recommendations generated by the processor, including for example suggestions to adjust price, modify product descriptions, change packaging methods, or alter shipping options.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

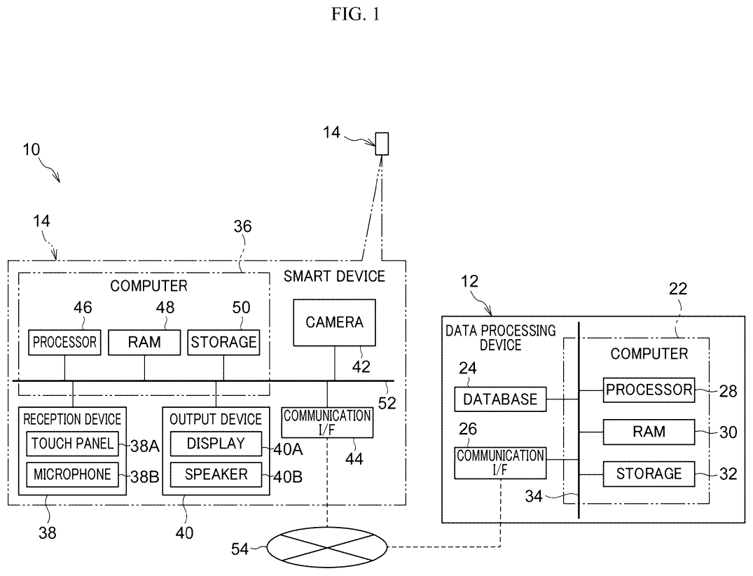

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

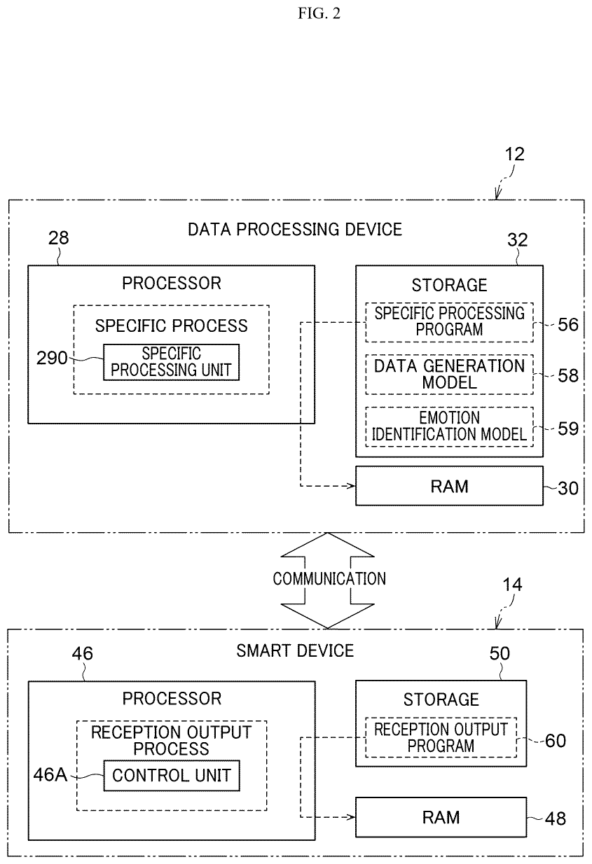

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional listing and sales management systems for network-based commerce primarily rely on fixed rule-based workflows and static templates. In such systems, a server typically generates a sales page by simply placing product information into predetermined layouts, and communication with purchasers is handled either manually by a seller or by simple keyword-based auto-reply mechanisms. Logistics handling and review analysis are likewise implemented with isolated, rigid components. As a result, the underlying computer systems are not optimized to dynamically adapt their data processing pipelines in response to heterogeneous inputs such as complex product attributes, free-form natural language inquiries, and unstructured evaluation texts.

In particular, non-technical burdens on the seller, such as crafting an appropriate sales page, selecting suitable layouts, generating consistent responses to purchaser inquiries, and extracting actionable insights from accumulated reviews, must often be addressed manually outside the system. From the standpoint of computer technology, this means that the server fails to fully utilize its processing resources to orchestrate end-to-end data flows. Existing systems do not integrate a generative AI model as a core component of their data processing architecture, but rather, at best, use isolated natural language utilities that do not control template selection, communication flow, or review-driven feedback loops. Consequently, the system architecture does not improve how processors select representations of data, structure communication channels, or manage feedback from evaluation information.

Moreover, conventional architectures treat review analysis and user sentiment analysis as offline, human-driven tasks or simple statistical aggregations. Review text and user sentiment are not tightly coupled to the system's operational parameters such as pricing, page configuration, and suggested improvements. The processor therefore cannot automatically reconfigure or guide these parameters in a principled, machine-driven manner. This lack of integration causes inefficiencies such as duplicated data flows, suboptimal database queries, and fragmented external API calls, leading to increased latency and resource consumption.

There is therefore a need for a computer-implemented system in which a processor cooperates with a generative AI model, via structured prompt sentences, to perform core operations including (i) analysis of merchandise information and dynamic template selection for sales information display screens, (ii) semi-automatic communication processing with purchasers, (iii) semi-automatic delivery processing through external information processing apparatuses, and (iv) systematic analysis of evaluation information and user emotion state. By tightly coupling these functions to a generative AI model and configuring the processor to generate and supply prompt sentences as internal control signals, the system can improve the efficiency, adaptability, and automation of the computer's data processing pipeline. The technical problem to be solved is to provide an improved server-side architecture and processing method that restructures how a processor manages product, communication, logistics, and review data, thereby reducing computational overhead, lowering manual intervention, and enhancing the responsiveness and scalability of the overall computer system.

The specific processing by the specific processing unit 290 of the data processing device 12 in Example 1 is realized by the following means.

The present invention provides a server comprising a processor and a memory storing instructions which, when executed by the processor, cause the processor to acquire merchandise information, analyze the merchandise information based on identification information and attribute information, select a generic template according to an analysis result, and generate a sales information display screen by automatically assigning image information and description information to the generic template by generating and supplying a prompt sentence to a generative AI model to perform at least part of the analysis and template selection; to acquire price information associated with the sales information display screen based on user input, record the price information in association with the sales information display screen, and control a publication state of the merchandise information based on the price information; to receive inquiry information or order information transmitted from a prospective purchaser, generate response candidate information by inputting a prompt sentence including the inquiry information and the merchandise information into the generative AI model, obtain the response candidate information from the generative AI model, present the response candidate information on a seller display screen, and transmit confirmed response information to execute communication processing in a semi-automatic manner; to acquire transaction information based on the order information, transmit destination information and merchandise attribute information included in the transaction information to a functional interface of an external information processing apparatus for delivery, obtain delivery identification information and delivery identification medium data, store the delivery identification medium data in a storage medium, obtain delivery status information based on the delivery identification information, and execute delivery processing in a semi-automatic manner by notifying the delivery status information to a seller display screen and a purchaser display screen; to collect evaluation information accumulated in association with the merchandise information, generate and input a prompt sentence including aggregated evaluation text, the merchandise information, and the price information into the generative AI model, obtain analysis result information including improvement candidate information for merchandise performance and review candidate information for price setting, and generate and output improvement proposal information and price review proposal information based on the analysis result information. This enables the server to implement an integrated, AI-assisted data processing pipeline in which generation and use of prompt sentences serve as internal control mechanisms for invoking the generative AI model, thereby improving how the computer selects templates, manages communication flows, coordinates delivery processing with external systems, and transforms unstructured evaluation data and user sentiment into structured operational guidance, resulting in reduced manual processing, more efficient resource utilization, and enhanced responsiveness of the network-based commerce system.

The term “merchandise information” refers to information used to identify and describe an item to be sold, including at least identification information, attribute information, and any related descriptive data used for generating a sales information display screen.

The term “identification information” refers to information that uniquely or quasi-uniquely identifies merchandise, such as a code, number, string, or combination thereof, usable as a key for retrieval and association of data in one or more storage resources.

The term “attribute information” refers to information representing one or more properties of merchandise, including, for example, category, type, specifications, features, manufacturer-related metadata, dimensions, or other descriptive attributes.

The term “generic template” refers to a layout definition or structural data format, independent of a specific merchandise item, that specifies positions and relationships of components such as text areas, image areas, and price display areas for generating a sales information display screen.

The term “sales information display screen” refers to a presentation structure generated by the system for displaying merchandise-related information, including at least image information, description information, and price information, via a user interface such as a web page or application screen.

The term “image information” refers to visual content data associated with merchandise, including static images, icons, thumbnails, or other graphical representations that can be rendered in the sales information display screen.

The term “description information” refers to textual or structured narrative data describing merchandise, including titles, summaries, feature lists, usage instructions, or other explanatory content

The term “price information” refers to data indicating a monetary amount or pricing condition associated with merchandise, including a listing price, discount condition, or other numeric or symbolic representation of value.

The term “user” refers to a human operator or entity interacting with the system through a terminal or user interface, including at least a seller, and optionally including a purchaser or prospective purchaser.

The term “prospective purchaser” refers to an entity that accesses the sales information display screen, generates inquiries, or initiates purchase-related actions with respect to merchandise.

The term “seller display screen” refers to a user interface provided to a seller by the system, through which the seller can view system-generated information, including response candidate information, delivery status information, improvement proposal information, and price review proposal information, and can input control data or confirmations.

The term “purchaser display screen” refers to a user interface provided to a purchaser or prospective purchaser by the system, through which the purchaser can view sales information, order information, delivery status information, and communication responses.

The term “inquiry information” refers to information including at least natural language text or structured data transmitted by a prospective purchaser to request clarification, ask questions, or otherwise communicate regarding merchandise.

The term “order information” refers to information representing an order transaction initiated by a purchaser, including at least an identifier of merchandise, quantity, pricing data, purchaser identifier, and destination information.

The term “transaction information” refers to information derived from or associated with order information, including at least destination information, merchandise attribute information, pricing conditions, and identifiers required for delivery and status tracking.

The term “destination information” refers to information indicating a physical or virtual delivery destination for merchandise, including at least address data, contact data, and any additional details required for delivery processing.

The term “merchandise attribute information” refers to a subset of attribute information relevant to logistics and delivery processing, including, for example, size, weight, packaging requirements, or handling conditions of the merchandise.

The term “external information processing apparatus for delivery” refers to an external system or service that performs delivery-related information processing, such as generating delivery identification information, providing delivery identification medium data, and supplying delivery status information via a functional interface.

The term “functional interface” refers to an interface, such as an application programming interface, protocol endpoint, or message-based interface, enabling the system to exchange structured data with an external information processing apparatus.

The term “delivery identification information” refers to information, including at least a tracking identifier or shipment code, used to uniquely identify a delivery item within a delivery or logistics system.

The term “delivery identification medium data” refers to data usable to generate or represent a delivery medium, such as a label, barcode, or machine-readable code, that physically or digitally associates merchandise with delivery identification information.

The term “delivery status information” refers to information, obtained from an external information processing apparatus for delivery, indicating a current or historical state of a shipment, such as created, in transit, out for delivery, or delivered.

The term “storage medium” refers to any non-transitory computer-readable medium used to store data, including, for example, semiconductor memory, magnetic storage, optical storage, or other storage resources.

The term “evaluation information” refers to information representing feedback regarding merchandise, including at least reviews, ratings, comments, or other evaluation texts provided by purchasers or users.

The term “aggregated evaluation text” refers to text data produced by collecting, combining, or summarizing multiple pieces of evaluation information for use in analysis by a generative AI model.

The term “analysis result information” refers to information produced by processing input data, including at least improvement candidate information and price review candidate information, obtained from a generative AI model or other analysis functions.

The term “improvement candidate information” refers to information indicating potential modifications or enhancements to merchandise characteristics, descriptions, or associated services, derived from analysis of evaluation information, merchandise information, and related data.

The term “price review candidate information” refers to information indicating potential adjustments, alternatives, or strategies regarding price information, derived from analysis of evaluation information, merchandise information, and current price information.

The term “improvement proposal information” refers to information generated by the processor based on analysis result information, formatted or structured for presentation to a seller as suggested actions for improving merchandise performance or presentation.

The term “price review proposal information” refers to information generated by the processor based on analysis result information, formatted or structured for presentation to a seller as suggested actions for revising or optimizing price settings.

The term “generative AI model” refers to an information processing model, implemented by hardware and/or software, that generates textual or other output data in response to one or more input prompt sentences, based on learned parameters obtained from training data.

The term “prompt sentence” refers to structured input data provided to a generative AI model, including at least natural language instructions and context information, that specifies a task to be performed and the data to be processed by the generative AI model.

The term “response candidate information” refers to information representing one or more suggested responses generated by the system, including at least responses produced using a generative AI model based on inquiry information and merchandise information.

The term “confirmed response information” refers to information representing a response selected or approved by a seller, potentially after editing a response candidate, and transmitted from the system to a prospective purchaser.

The term “emotion state information” refers to information describing an estimated emotional condition of a user, derived from analysis of text data and optionally other signals using an emotion analysis function or generative AI model.

The term “emotion estimation condition” refers to information indicating conditions, parameters, or criteria used in estimating an emotion state, including, for example, target emotion categories, analysis scope, or weighting rules.

The term “emotion analysis information processing function” refers to a function implemented by software and/or hardware that processes input data to estimate an emotion state, which may be provided as part of, or separately from, a generative AI model.

The term “information processing function for emotion state estimation” refers to a set of operations performed by a processor, a generative AI model, or another analysis component to derive emotion state information from input text data and related context.

The term “publication state” refers to a state in which merchandise information and its associated sales information display screen are made accessible to at least one prospective purchaser via a communication network.

The term “publishable state” refers to a condition in which a sales information display screen is configured and validated such that it can be transitioned into the publication state without requiring additional editing operations.

The term “semi-automatic manner” refers to a processing mode in which a computer system performs at least part of a sequence of operations automatically, while allowing or requiring a user to approve, modify, or supplement specific data or actions at one or more points in the sequence.

The term “AI-assisted data processing pipeline” refers to a sequence of data processing operations executed by the system in which generation of prompt sentences and invocation of a generative AI model are integrated as internal components to transform, analyze, or generate data used by subsequent processing stages.

In one or more embodiments, a server, a terminal, and a user cooperate to implement a network-based commerce support system that uses a generative AI model controlled via prompt sentences to improve internal computer processing for page generation, communication handling, logistics coordination, and review analysis.

### A. Hardware and Software Configuration

The server uses one or more physical processors, main memory, and non-transitory storage devices. The server executes an operating system such as a general-purpose server operating system and application software implemented, for example, using a web application framework.

The server connects to a data storage subsystem that may include a relational database management system, an object storage service, and a cache memory system.

The server uses a relational database engine, such as a structured query language database, to store structured data including merchandise information, template definitions, messages, orders, delivery records, reviews, and AI-generated suggestions. The server uses object storage, such as a network-accessible file store, to store binary data including merchandise images and delivery label files. The server uses a cache system, such as an in-memory key-value store, to store frequently accessed metadata for rapid retrieval.

The server uses a generative AI model hosted either on the same machine or on a separate computing resource accessible via a network. In one embodiment, the generative AI model is implemented as a transformer-based neural network with multiple encoder-decoder layers, multi-head self-attention mechanisms, and learned token embeddings. The generative AI model processes input sequences of tokens derived from prompt sentences and outputs sequences of tokens representing generated text. The server invokes this model via an application programming interface and passes prompt sentences encoded as text together with control parameters such as maximum output length and temperature.

The terminal uses a computing apparatus such as a smartphone, tablet, or personal computer. The terminal executes a user interface program, such as a web browser or native application, configured to display seller display screens and purchaser display screens, and to send and receive data via a communication network such as the Internet. The terminal uses standard UI components to display text, images, and interactive elements, but all core logic for template selection, communication processing, logistics processing, and review analysis resides on the server.

The user operates the terminal to input merchandise information, confirm suggested responses, and review improvement proposals and price review proposals. The user does not directly control the generative AI model but indirectly instructs the generative AI model through operations that cause the server to construct and transmit appropriate prompt sentences.

### B. Data Structures and Internal Modules

The server uses specific data structures to improve processing efficiency and enable structured interaction with the generative AI model.

The server stores merchandise information in a product table, which includes at least the following fields: an internal product key, external identification information, attribute information (such as category, specification codes, and feature flags), description information, image references, price information, and publication state flags. The identification information is stored in an indexed column that is used as a primary retrieval key for joining with external product metadata.

The server stores layout definitions in a template table. Each template record contains a template identifier, layout metadata (such as positions and sizes of regions for images, titles, feature lists, and price display), and constraints indicating which categories of merchandise are compatible with the template. The server also maintains a template-feature mapping table that associates semantic features derived from merchandise attribute information with specific templates.

The server stores messages in a communication table that includes message identifiers, associated product identifiers, sender and receiver identifiers, message text, timestamps, status flags, and foreign keys to a message-suggestion table. The message-suggestion table stores response candidate information generated by the generative AI model, including suggestion text, confidence scores, and metadata indicating the prompt configuration used to obtain the suggestion.

The server stores order and delivery information in an order table and a delivery table. The order table contains fields such as order identifier, product identifier, buyer identifier, seller identifier, quantity, total price, and order status. The delivery table stores destination information, delivery identification information, delivery identification medium data references, and delivery status information. The server uses foreign key constraints to maintain referential integrity between the order table and the delivery table.

The server stores reviews in a review table, with fields including review identifier, product identifier, rating value, evaluation text, timestamps, and normalized sentiment scores. The server also stores AI-based suggestions in a suggestion table, which contains improvement candidate information and price review candidate information, each associated with a product identifier and time of generation.

The server decomposes its functional behavior into modules including: a page generation module, a communication management module, a logistics coordination module, a review analysis module, and an emotion analysis module. Each module is executed by the processor and uses the generative AI model through prompt sentences in a controlled and structured fashion.

### C. Generative AI Model Configuration and Training

The server uses a generative AI model configured as a deep neural network with a multi-layer transformer architecture. The model comprises an embedding layer that converts tokens (words or subword units) into fixed-length vectors, a stack of attention layers, and a final projection layer that maps hidden states to a vocabulary distribution.

The server trains the generative AI model, or uses a model that has been fine-tuned, using a dataset of domain-specific texts including product descriptions, customer inquiries, support responses, reviews, and pricing discussions. During training, the server minimizes a loss function such as cross-entropy between predicted token distributions and ground truth tokens. The server updates model weights using an optimization algorithm such as stochastic gradient descent with adaptive momentum. The model is trained using a large number of iterations to learn relationships between merchandise attributes, natural language descriptions, and typical communication patterns.

The server may further fine-tune portions of the generative AI model using specialized prompt-response pairs for tasks such as template selection and improvement suggestion generation. In such fine-tuning, the server defines target outputs such as template identifiers or structured suggestions and adjusts the model so that certain token sequences correspond more strongly to particular templates or suggestion types. The server can encode template identifiers or feature tags as special tokens to bias the model toward generating specific control outputs.

The server uses attention mechanisms to attend to relevant parts of input prompt sentences, such as identification information, attribute information, review phrases, and sentiment cues. This internal structure enables the generative AI model to process heterogeneous inputs more effectively than a simple rule-based or keyword-based approach.

### D. Use of Prompt Sentences and Technical Effect

The server uses prompt sentences as internal control signals that specify tasks and provide structured context to the generative AI model. The server constructs prompt sentences that include both natural language instructions and machine-readable delimiters to separate sections such as product metadata, user questions, and evaluation texts. For example, when generating improvement suggestions based on reviews, the server may form a prompt sentence such as: “You are an expert product manager. Analyze the following customer reviews for a wireless audio device (current price: 5000).

### Reviews:

1. The sound quality could be a little better.
2. Battery life is fine, but the audio is slightly muffled.
3. Comfortable to wear, but the high tones are weak.

Based on these reviews, list concrete improvement points for the product, focusing on sound quality and overall value. Provide the answer in bullet points.”

When analyzing price appropriateness, the server may form a prompt sentence such as:
“You are a pricing analyst. The product is wireless earphones with a current price of 5000. Here are some reviews:
1. Good value for the price.
2. Feels a bit expensive given the sound quality.
3. If the sound was better, I wouldn't mind paying more.

Analyze whether the current price is appropriate and propose specific price adjustment options with reasons.”

When preparing a communication response, the server may form a prompt sentence such as:
“You are a support agent for a wireless earphones product. The buyer asks: ‘How long is the warranty period for this product?’ Draft a concise and polite answer, in the language of the question, suitable for an online marketplace.”

The server tokenizes these prompt sentences, prepares a sequence of tokens, and feeds them into the generative AI model. The server decodes the generated tokens into text, filters or truncates the output according to internal rules, and then stores the output in appropriate tables.

By using prompt sentences in this structured manner, the server causes the generative AI model to perform tasks that go beyond human-style narrative generation. The prompt sentences encode system-specific metadata and control patterns, allowing the model to act as a flexible computational component that transforms heterogeneous inputs into structured outputs that are immediately usable by other modules. This reduces the number of hard-coded rules and simplifies the logic for integrating new data types or workflows, improving maintainability and extensibility of the software architecture.

### E. Page Generation Embodiment

The server uses the page generation module to generate sales information display screens in response to merchandise information being registered. The server extracts identification information and attribute information from the merchandise information. The server retrieves related metadata, such as product category and specification codes, from the database or an external catalog. The server constructs a feature vector representing the merchandise, combining fields such as category identifiers, numerical attributes, and binary flags indicating presence of certain features.

The server may use a lightweight algorithm such as a decision tree or a learned classifier to pre-select a set of candidate templates based on the feature vector. The server then forms a prompt sentence summarizing the merchandise attributes and the set of candidate templates, and requests the generative AI model to recommend a final template and possible layout variations. An example prompt sentence may be:
“You are a layout selection assistant. The product has the following attributes: category=audio device, form factor=in-ear, feature=noise cancellation, price range=mid.

There are three available templates:
Template A: large main image, short title, short feature list.
Template B: medium image, long title, detailed feature list.
Template C: multiple images, short title, emphasis on specifications.
Select the most appropriate template and briefly justify the choice.”

The server parses the output from the generative AI model, extracts the selected template identifier, and applies that template to generate the sales information display screen. The server uses a template engine to merge description information and image information into the structure defined by the template. By using the generative AI model and the candidate template set, the server reduces the search space and ensures that the chosen template matches subtle attribute patterns. This improves both selection accuracy and processing speed compared to exhaustive or purely rule-based selection.

The server caches frequently used combinations of attribute patterns and templates in the cache memory. When a similar merchandise item is processed, the server retrieves the recommended template directly from the cache, bypassing the generative AI model invocation and reducing response latency. This caching mechanism is technically enabled by the structured association between feature vectors, prompt patterns, and template identifiers.

### F. Communication Management Embodiment

The server uses the communication management module to semi-automate communication between the seller and the prospective purchaser. The server receives inquiry information and stores it with associated product identifiers and user identifiers. The server pre-processes inquiry text by normalizing characters, removing noise tokens, and detecting the language. The server then constructs a prompt sentence that includes the normalized inquiry text, selected merchandise fields, and constraints on style or length.

The server sends this prompt sentence to the generative AI model and obtains response candidate information. The server additionally post-processes the candidate responses by applying syntactic and semantic checks, such as verifying that the response does not contain disallowed content and that it remains consistent with stored merchandise information. The server may append structured tags to the prompt sentence to request specific answer formats that are easier to validate. The server presents the response candidate information to the seller display screen. The user can edit, approve, or reject the recommendation. When the user confirms a response, the server stores confirmed response information and transmits it to the prospective purchaser. This semi-automatic process reduces manual typing workload, but, more importantly from a technical perspective, it changes how the server computes and stores response options. Instead of relying on static if-then rules, the server uses the generative AI model to create context-sensitive responses, and the server's validation and caching layers constrain the responses for consistency and safety. The result is improved coverage of diverse inquiry patterns without sacrificing performance, because the server only uses the generative AI model and complex checks when necessary.

### G. Logistics Coordination Embodiment

The server uses the logistics coordination module to handle delivery identification information, delivery identification medium data, and delivery status information in a semi-automatic manner. The server retrieves transaction information from the order table, extracts destination information and merchandise attribute information, and structures the data according to the specification of an external information processing apparatus for delivery.

The server constructs structured requests to the functional interface of the external information processing apparatus, including metadata such as weight, dimensions, and preferred delivery options. The external information processing apparatus returns delivery identification information and delivery identification medium data. The server stores references to this medium data in the delivery table and stores the binary representation of the medium, such as a barcode image or label file, in object storage.

The server periodically queries the external information processing apparatus using the delivery identification information, and the server updates delivery status information in the delivery table. The server notifies the seller display screen and the purchaser display screen of status changes. The technical effect of this coordination is that the server maintains a synchronized, normalized record of delivery status across multiple external carriers and uses a consistent schema for status fields. The server can detect anomalies such as delayed shipments by comparing timestamps and state transitions, enabling further automated actions.

### H. Review Analysis and Emotion Analysis Embodiment

The server uses the review analysis module to aggregate evaluation information for each product. The server collects review texts, filters spam or irrelevant content, and transforms the text into normalized sequences. The server groups reviews by product and constructs aggregated evaluation text. For each product, the server attaches current price information and merchandise attributes to build a comprehensive context.

The server forms prompt sentences that bundle aggregated evaluation text, price information, and merchandise attributes. The server may include explicit markers indicating rating distributions, sentiment scores, and frequently occurring keywords. The generative AI model receives these prompt sentences and generates analysis result information. The server parses this information, extracts improvement candidate information and price review candidate information, and stores them in structured fields.

The server uses the emotion analysis module to estimate emotion state information from user-related text, such as seller feedback or purchaser communications. The server applies a classifier or generative AI-based function that has been trained to map text to a vector of emotion categories. The server uses an error function such as cross-entropy to adjust classifier parameters during training, and the server may use data augmentation techniques, such as synonym replacement and back-translation, to increase training data diversity.

The server associates emotion state information with evaluation information and merchandise information. When generating improvement proposal information or price review proposal information, the server adjusts recommendations based on emotion patterns. For example, when negative emotion states are predominant in reviews, the server can prioritize certain types of improvements. This integration of emotion-aware analysis improves the accuracy and relevance of generated proposals.

### I. Technical Effects and Computer Technology Improvement

By integrating generative AI model operations, prompt sentence generation, and structured database management, the server improves the functioning of the computer system itself. The server reorganizes internal processing so that multiple tasks—template selection, communication suggestion, logistics coordination, and review analysis—are executed in a shared AI-assisted pipeline instead of separate, hand-coded modules.

The server reduces the number of hard-coded rules and database lookups by replacing them with model-driven inferences that operate over semantic representations. This reduces programming complexity and makes it possible to handle new merchandise types and inquiry forms without substantial changes to procedural code. The server employs caching strategies and pre-filtered candidate sets to ensure that calls to the generative AI model are focused and efficient, resulting in lower communication overhead and shorter response times.

The server improves data management by enforcing consistent schemas for merchandise information, communication logs, and suggestion records. The server uses the generative AI model to produce outputs that are aligned with these schemas through constrained prompt sentences and subsequent parsing. This increases the accuracy of data insertion and decreases the need for human correction.

The server improves computational efficiency by combining pre-processing, model invocation, and post-processing stages in a pipeline optimized for vectorized operations and batched inference. When processing multiple reviews or inquiries, the server can batch prompt sentences to process them in parallel on specialized hardware such as graphical processing units, reducing average processing time per item.

The server uses specific training methods, loss functions, and architectural configurations for the generative AI model to ensure that the model behaves predictably under the structured prompts used by the system. This is different from a generic text generator because the server configures the prompt sentences and model parameters to support deterministic mappings from particular data structures to desired output formats. The result is a technical improvement to how the computer transforms heterogeneous, unstructured inputs into consistent, structured outputs at scale.

### J. Alternative Embodiments and Variations

The server may employ different neural network architectures for the generative AI model, such as encoder-only architectures for classification-style tasks and decoder-only architectures for generation tasks. The server may deploy separate specialized models for template selection, communication suggestion, and review analysis, or may combine them into a single multi-task model using task-specific control tokens.

The server may store templates in different formats, such as XML or JSON layouts, and may allow dynamic update of template libraries without changing core code. In some embodiments, the server may allow the generative AI model to propose modifications to existing templates, which the server then validates and stores as new template variants.

The server may use different optimization algorithms, such as adaptive gradient methods or second-order methods, to train or fine-tune the generative AI model. The server may adjust training hyperparameters, such as learning rate, batch size, and regularization factors, to balance performance and resource consumption.

The server may integrate additional data sources, such as historical sales trends and inventory levels, into prompt sentences for price review analysis. The server may also use temporal features, such as seasonality indicators, as special tokens in the prompt sentences to further refine suggestions.

The server may deploy the generative AI model on-premises or as a remote service; in either case, the server remains responsible for constructing and interpreting prompt sentences and for managing the resulting structured outputs. The terminal and user operations remain essentially the same, as the heavy computation and data management are centralized in the server.

By these embodiments and variations, the server, terminal, and user cooperate to implement a technical solution in which a generative AI model, orchestrated through prompt sentences, is used not merely to automate human tasks, but to restructure and enhance the internal data processing capabilities of the computer system, thereby achieving improved processing speed, accuracy, data management, and communication efficiency.

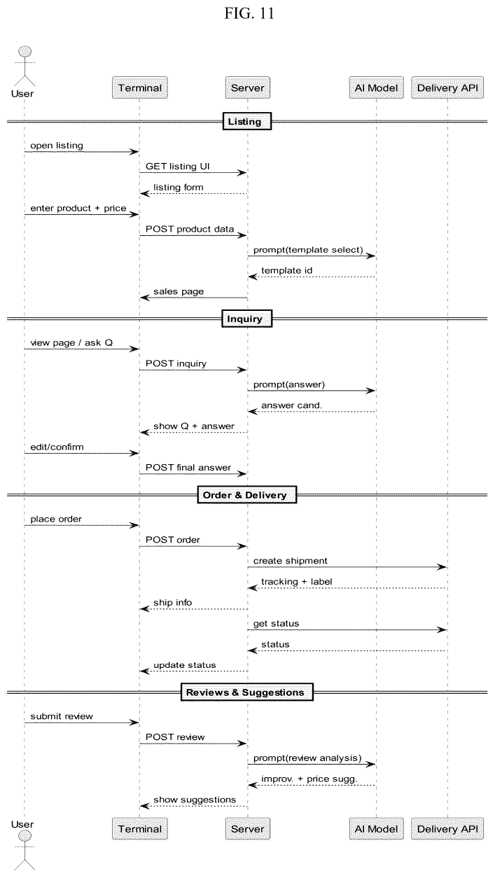

The following describes the processing flow using FIG. 11.

### Step 1:

User operates the terminal to access a listing interface provided by the server.

User inputs merchandise information, including at least identification information and attribute information, into input fields displayed on the terminal.

Terminal receives the user's keystrokes and selections as input and structures them into merchandise information data.

Terminal transmits the merchandise information as a request to the server over a network.

The input of this step is raw user input (identification code, name, attributes), and the output is structured merchandise information data delivered from the terminal to the server.

### Step 2:

Server receives the merchandise information from the terminal.

Server parses the merchandise information to extract identification information and attribute information, performing validation such as format checking and allowed value checking.

Server executes data processing to store the merchandise information in a product table of a database, generating an internal product key as an index.

Server may query external or internal catalog data sources using the identification information as a lookup key to obtain additional attribute information, which is also stored in the database.

The input of this step is the structured merchandise information from the terminal, and the output is a normalized product record with an internal product key stored in the database.

### Step 3:

Server analyzes the stored identification information and attribute information to prepare template selection.

Server computes a feature representation of the merchandise, for example by mapping categories and attributes to numerical or categorical feature codes.

Server optionally filters a template table to select a candidate set of generic templates compatible with the merchandise category.

Server constructs a prompt sentence that summarizes the merchandise features and the available templates for use by the generative AI model.

The input of this step is the product record (identification and attribute information), and the output is a feature representation and a candidate template set, together with a constructed prompt sentence.

### Step 4:

Server inputs the prompt sentence into the generative AI model via an application programming interface.

Server encodes the prompt sentence into tokens, sends the token sequence and model parameters (such as maximum length and temperature) to the generative AI model, and receives generated output tokens.

Server decodes the generated output tokens into text and parses the text to extract a selected template identifier and any layout-related metadata.

Server validates the selected template identifier against the template table, discarding invalid references and, if necessary, falling back to a default template.

The input of this step is the prompt sentence prepared by the server, and the output is a validated template identifier and layout metadata derived from the generative AI model's response.

### Step 5:

Server uses the selected template identifier to retrieve a corresponding generic template definition from the template table.

Server combines the template definition with description information and image references associated with the merchandise record.

Server executes a page generation process using a template engine, in which placeholders in the template are replaced with actual description texts and image URLs.

Server generates a sales information display screen representation, such as a structured layout description, and stores it in association with the internal product key.

The input of this step is the template identifier, layout metadata, and merchandise description and image information, and the output is a complete sales information display screen representation stored in the database.

### Step 6:

Server sends the generated sales information display screen data to the terminal in response to a display request.

Terminal receives the sales information display screen data and renders it on a user interface, showing the title, images, description, and an empty price field.

User views the displayed sales information and decides on price information to set for the merchandise.

The input of this step is the stored sales information display screen representation, and the output is a rendered display on the terminal and a decision by the user regarding price information.

### Step 7:

User inputs price information (for example, a numeric amount) using the terminal interface. Terminal receives the price information and associates it with the internal product key.

Terminal sends an update request to the server that includes the internal product key and the price information.

The input of this step is the user-entered price value, and the output is a structured price information message transmitted to the server.

### Step 8:

Server receives the price information from the terminal and validates it against preconfigured constraints, such as numeric type, allowed minimum and maximum values, and currency rules.

Server updates the corresponding product record in the database to store the price information in association with the internal product key.

Server updates the sales information display screen representation to include the price information, and changes the publication state of the merchandise to a publishable or published state.

Server records the new state in the database and, if necessary, updates routing entries or index data for public access.

The input of this step is the structured price information message, and the output is an updated product record with price information and a publication state that enables public viewing.

### Step 9:

Server exposes the sales information display screen to prospective purchasers via a purchaser display screen interface.

Terminal used by a prospective purchaser retrieves and displays the sales information display screen by requesting it from the server.

User acting as a prospective purchaser views the merchandise information and may generate inquiry information or order information.

The input of this step is the published sales information display screen data on the server, and the output is visual presentation of the merchandise to prospective purchasers and potential creation of inquiry or order data.

### Step 10:

Terminal used by a prospective purchaser sends inquiry information to the server, including text questions associated with the merchandise.

Server receives the inquiry information, validates it, and stores it in a communication table with links to the product and user identifiers.

Server pre-processes the inquiry text, including normalization, language detection, and optional keyword extraction, and then constructs a prompt sentence that includes the normalized inquiry text, selected merchandise attributes, and constraints for response style.

The input of this step is raw inquiry text from the prospective purchaser, and the output is a stored and normalized inquiry record together with a constructed prompt sentence for response generation.

### Step 11:

Server inputs the constructed prompt sentence into the generative AI model to obtain response candidate information.

Server tokenizes the prompt sentence, sends the tokens to the generative AI model, and receives a sequence of output tokens that are decoded into response text.

Server post-processes the response text by checking consistency with stored merchandise information, filtering prohibited content, and truncating or formatting the text according to predefined rules.

Server stores the validated response candidate information in the message-suggestion table and associates it with the original inquiry.

The input of this step is the normalized prompt sentence for communication, and the output is validated response candidate information generated and stored by the server.

### Step 12:

Server notifies the seller's terminal of the existence of new inquiry information and associated response candidate information.

Terminal used by the seller sends a request to fetch pending inquiries and corresponding response candidates.

Server replies with the inquiry text and response candidate information.

Terminal displays the inquiry and the suggested response to the user, allowing editing or confirmation.

The input of this step is the stored inquiry and response candidate records, and the output is a displayed pair of inquiry and suggestion on the seller display screen.

### Step 13:

User acting as the seller reads the inquiry and the response candidate on the terminal.

User may edit the suggested response to correct details or adjust tone, or may accept the suggestion without changes.

User confirms the response by activating a send or confirm control on the terminal.

The input of this step is the displayed inquiry and suggested response, and the output is confirmed response information entered by the user.

### Step 14:

Terminal sends the confirmed response information back to the server along with references to the corresponding inquiry record.

Server receives the confirmed response information, stores it in the communication table as a final response, and updates the inquiry status to indicate completion.

Server forwards the confirmed response information to the prospective purchaser's terminal or associated messaging channel.

The input of this step is confirmed response text and related identifiers, and the output is a stored final response record and a notification delivered to the prospective purchaser.

### Step 15:

Server monitors for order information generated from the purchaser display screen.

Server receives order information containing product identifier, quantity, purchaser identifier, and destination information, and records this information in the order table.

Server derives transaction information, including computed total price, shipment requirements based on merchandise attribute information, and delivery options.

The input of this step is order information from the purchaser, and the output is a stored order record and derived transaction information.

### Step 16:

Server uses the transaction information to prepare delivery-related data for an external information processing apparatus for delivery.

Server extracts destination information and merchandise attribute information, including at least weight and dimensions, and formats this data according to the functional interface specification of the external apparatus.

Server sends the formatted request to the external apparatus and receives delivery identification information and delivery identification medium data in return.

The input of this step is transaction information from the order record, and the output is delivery identification information and delivery identification medium data stored in the delivery table and object storage.

### Step 17:

Server stores the delivery identification medium data, such as a label or barcode, in an object storage system and records a reference to it in the delivery table.

Server sets the initial delivery status information (such as “label generated” or “ready for shipment”) and associates this status with the order.

Server notifies the seller display screen of the availability of the delivery identification medium and associated instructions.

The input of this step is delivery identification medium data and delivery identification information, and the output is updated delivery records and a notification to the seller terminal.

### Step 18:

User acting as the seller accesses the seller display screen on the terminal and retrieves delivery information for the order.

Terminal displays the delivery identification information and provides a link or view of the delivery identification medium, such as a shipping label.

User prints or otherwise uses the delivery identification medium to prepare the physical shipment.

The input of this step is delivery information and label reference from the server, and the output is a human-readable display and physical preparation of the shipment.

### Step 19:

Server periodically queries the external information processing apparatus using the delivery identification information.

Server receives updated delivery status information, such as “in transit” or “delivered,” and updates the delivery table accordingly.

Server notifies both the seller display screen and the purchaser display screen of significant status changes.

The input of this step is delivery identification information and external status responses, and the output is updated delivery status records and notifications transmitted to terminals.

### Step 20:

Server accumulates evaluation information, including reviews and ratings, associated with the merchandise.

Server aggregates evaluation texts for each product, performing text normalization and grouping to form aggregated evaluation text.

Server retrieves the current merchandise attributes and price information, and constructs a prompt sentence that includes the aggregated evaluation text, the merchandise attributes, and the price information.

The input of this step is individual review records from the review table, and the output is aggregated evaluation text and a corresponding prompt sentence for analysis.

### Step 21:

Server inputs the prompt sentence for review analysis into the generative AI model.

Server processes the model output to extract improvement candidate information and price review candidate information.

Server performs parsing operations to identify bullet points, recommendations, and price range suggestions, and stores the extracted data in the suggestion table in a structured form.

The input of this step is the prompt sentence for review and price analysis, and the output is structured improvement candidate information and price review candidate information stored in the database.

### Step 22:

Server optionally obtains emotion state information related to users by processing user-related text data with an emotion analysis information processing function or a generative AI-based classifier

Server associates emotion state information with evaluation information and merchandise information, and adjusts the selection or weighting of improvement candidate information and price review candidate information accordingly.

Server generates improvement proposal information and price review proposal information, incorporating emotion-aware adjustments, and stores these proposals in association with each product.

The input of this step is user-related text and previously stored suggestions, and the output is refined improvement proposal information and price review proposal information.

### Step 23:

Server responds to a request from the seller's terminal to retrieve suggestions for a specific product.

Server gathers the relevant improvement proposal information and price review proposal information from the suggestion table.

Server sends the suggestions to the terminal, formatted for display in a dashboard or dedicated improvement screen.

Terminal displays the suggestions to the user, enabling the user to understand recommended actions.

The input of this step is a product identifier from the terminal, and the output is a set of displayed, structured suggestions for product improvement and price review.

### Step 24:

User reviews the displayed improvement proposal information and price review proposal information on the terminal.

User may modify merchandise information or price information on subsequent screens in response to these suggestions.

Terminal sends updated merchandise or price information to the server, which processes these updates in the same manner as initial registration and pricing operations.

The input of this step is the displayed suggestions and user decisions, and the output is updated merchandise records and pricing records that have been influenced by model-derived analysis and internal server processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic commerce systems largely treat product listing, buyer communication, and review analysis as disconnected workflows that depend heavily on manual input and ad hoc scripts. A seller is typically required to manually compose product descriptions, select page layouts, respond to buyer inquiries one by one, and periodically read through large volumes of reviews to identify problems and adjust pricing. Even where some automation is introduced, it is often limited to rule-based templates or static keyword matching that do not scale well or adapt to nuanced language, and that cannot effectively generalize to new products or changing market conditions.

Existing systems also generally process natural language content in a simplistic manner that does not exploit modern generative models. Product information, buyer inquiries, and reviews are usually handled by separate subsystems, each with its own narrow logic. As a result, the system cannot consistently transform heterogeneous text and structured data into coherent, context-aware outputs such as high-quality listing pages, precise answers to buyer questions, or actionable improvement proposals. This fragmentation leads to duplicated processing, inconsistent use of product context, and increased latency and resource consumption on the server side.

From a computer technology standpoint, current platforms do not provide an integrated server-side architecture that systematically uses prompt-driven interaction with generative models as a programmable component of the data processing pipeline. In typical implementations, any use of a generative model is handled as an external, loosely coupled feature, without a uniform mechanism for: (i) transforming structured transaction data and accumulated logs into model-ready input; (ii) post-processing model outputs into machine-consumable commands or database updates; and (iii) iteratively refining model prompts and outputs based on real-world feedback. Furthermore, conventional systems lack mechanisms for combining time-series analysis of inquiries and reviews with dynamic prompt generation to derive higher-level operational strategies. While log data may be stored, it is seldom integrated into a closed-loop control process in which server logic automatically identifies recurring issues, generates strategic improvement proposals across multiple items, and presents them in a consolidated management interface. As a result, the system cannot efficiently utilize its own historical interaction data to improve future responses, pricing logic, or page composition in a systematic, computationally efficient manner.

Therefore, there is a need for an improved computer-implemented system and server-side processing technique that: (i) integrates acquisition and enrichment of product information, inquiry analysis, and review analysis into a unified pipeline; (ii) programmatically generates prompt sentences to drive a generative AI model for multiple tasks such as listing generation, automatic response generation, and improvement proposal creation; (iii) manages these tasks through structured, machine-interpretable workflows rather than ad hoc human operations; and (iv) thereby improves the efficiency, scalability, and technical performance of the underlying computing system in handling large volumes of natural-language-centric commerce data.

The specific processing by the specific processing unit 290 of the data processing device 12 in Application Example 1 is realized by the following means.

The present invention provides a server comprising a processor and a memory storing instructions that, when executed by the processor, cause the processor to acquire merchandise information including at least identification information, supplement the merchandise information based on the identification information, generate prompt sentences as structured control data for a generative AI model using the supplemented merchandise information, inquiry information, and evaluation information as input, invoke the generative AI model to generate listing display information, automatic response sentences, and proposal information, select and construct display layouts based on generated content, and update stored merchandise information, price information, and delivery status information in response to seller operations and model outputs. This enables a technical improvement in computer functionality by providing an integrated, prompt-driven processing architecture in which the server systematically transforms structured commerce data and unstructured natural language data into model-ready inputs, coordinates multiple generative and analytical operations within a unified workflow, reduces manual intervention and duplicated processing, and thereby enhances the efficiency, scalability, and responsiveness of server-side processing for electronic commerce applications.

The term “merchandise information” refers to digital data representing an item to be offered for sale, including at least identification information and optionally attribute information such as category, name, specifications, and manufacturer-related information.

The term “identification information” refers to data that uniquely or quasi-uniquely identifies a merchandise item within a catalog or database, such as a code, number, or other identifier.

The term “supplemented merchandise information” refers to merchandise information that has been expanded, corrected, or completed by the server based on the identification information, for example by retrieving additional attribute information from a data storage or an external data source.

The term “merchandise attribute information” refers to structured data describing characteristics of a merchandise item, including but not limited to category, size, material, functionality, compatible devices, and other specification-related attributes.

The term “sales information” refers to data used for commercial offering of a merchandise item, including price information, availability status, shipping conditions, and promotional information.

The term “listing display information” refers to data defining the content of a listing for a merchandise item, including at least a description sentence, sales information, and optionally images, feature lists, and other display elements.

The term “listing display screen” refers to a visual presentation generated on a terminal device based on listing display information and display layout information, and configured to present a merchandise item for sale.

The term “display layout information” refers to structured data defining a visual arrangement or template for presenting listing display information, including placement, order, style, and grouping of textual and graphical elements.

The term “generative information processing model” refers to a computational model, such as a generative AI model or language model, configured to generate text or other content in response to input data and a prompt sentence.

The term “generative AI model” refers to a machine learning model that generates output content, including natural language text, by processing input data and a prompt sentence using statistical or neural network techniques.

The term “prompt sentence” refers to a machine-interpretable text sequence or token sequence that instructs a generative information processing model how to process given input data and what type of output to generate.

The term “buyer” refers to a user or entity that views listings, makes inquiries, or purchases merchandise items through the system.

The term “seller” refers to a user or entity that registers merchandise information, configures listings, and provides merchandise items for sale through the system.

The term “purchaser terminal” refers to an information processing device, such as a client device, used by a buyer to access listing display screens, submit inquiries, and view responses.

The term “seller terminal” refers to an information processing device, such as a client device, used by a seller to register merchandise information, review proposals, confirm shipments, and manage listings.

The term “inquiry information” refers to text data and associated metadata representing a question or message submitted by a buyer regarding a merchandise item or transaction.

The term “automatic response sentence” refers to a natural language text output generated by the system, with or without seller confirmation, in response to inquiry information.

The term “evaluation information” refers to data submitted by a purchaser after a transaction, including at least one of a rating, review text, and feedback related to a merchandise item or service.

The term “proposal information” refers to data generated by the system that suggests specific actions to improve a merchandise item, adjust pricing, or modify listing content based on analysis of evaluation information and other data.

The term “merchandise improvement proposal” refers to proposal information that indicates one or more changes to physical or descriptive aspects of a merchandise item, such as feature enhancements, quality improvements, or clarification of specifications.

The term “price adjustment proposal” refers to proposal information that indicates one or more changes to price information, such as increasing, decreasing, or restructuring the price of a merchandise item.

The term “strategy proposal information” refers to proposal information that aggregates or generalizes improvement guidelines and price strategies across multiple merchandise items, based on analysis of accumulated inquiry information and evaluation information.

The term “emotional tendency” refers to an indication, derived from emotion analysis of text data, of overall sentiment or affective orientation, such as positive, negative, or neutral, associated with user feedback.

The term “evaluation tendency” refers to an indication, calculated per interest item, of how users typically rate or comment on specific aspects of a merchandise item, such as durability, price perception, or usability.

The term “interest item” refers to a particular aspect or attribute category of a merchandise item or service, for which evaluation or sentiment is separately analyzed, such as quality, design, price, or shipping.

The term “emotion analysis processing” refers to computational processing that analyzes text data to estimate an emotional state or sentiment, and outputs a metric such as an index value indicating an emotional state.

The term “index value indicating an emotional state” refers to a numerical or symbolic indicator produced by emotion analysis processing that represents an inferred emotional condition, such as frustration, satisfaction, or neutrality.

The term “priority of merchandise improvement content and price review content” refers to an ordering or weighting indicating which proposed improvements or price changes should be addressed earlier or with greater emphasis, determined based on analysis results and emotional states.

The term “transaction information” refers to data related to a commercial transaction, including at least order data, purchased items, quantities, buyer information, and payment status.

The term “destination information” refers to data specifying a delivery address or target destination for shipping a merchandise item.

The term “delivery service information processing apparatus” refers to an external information processing system associated with a logistics or delivery service, configured to receive control information for delivery procedures and to return delivery identification information.

The term “delivery identification information” refers to data for tracking or identifying a shipment, such as a tracking number, barcode data, or other delivery-related identifier.

The term “delivery display information” refers to data used to present delivery-related details, including at least delivery identification information and optionally destination information, on a seller terminal.

The term “delivery status information” refers to data indicating a current state of a shipment, such as prepared, dispatched, in transit, delivered, or delayed.

The term “time-series manner” refers to storage or processing of data ordered or indexed by time, such that later retrieval and analysis can consider chronological relationships.

The term “frequently occurring issues” refers to problem patterns or negative aspects that appear repeatedly in accumulated inquiry information or evaluation information.

The term “highly evaluated points” refers to features or aspects that are repeatedly associated with positive sentiment or high ratings in accumulated evaluation information.

The term “improvement guidelines” refers to generalized recommendations derived from analysis of multiple merchandise items, indicating preferred directions for product or service improvement.

The term “price strategy proposals” refers to generalized recommendations for pricing or price structures across multiple merchandise items, based on analysis of feedback, demand, and evaluation tendencies.

The term “management display screen” refers to a display screen provided to a seller or administrator that aggregates and presents strategy proposal information, proposal information, and related control data for managing multiple merchandise items and operations.

The term “control information” refers to data generated by the server for controlling or requesting operations of another system, such as a delivery service information processing apparatus, including instructions and necessary parameters.

The term “semi-automatic manner” refers to a mode of operation in which the system performs a sequence of processing steps automatically but permits or requires at least one user confirmation or intervention step.

In one embodiment, a server executes a network-based commerce support system that integrates product listing generation, buyer communication, and review-driven improvement proposals by using a generative AI model controlled through prompt sentences. The server operates on general-purpose computing hardware such as a multi-core processor, volatile and non-volatile memory, and network interfaces, for example on an x86-compatible processor, a random access memory device, a solid-state storage device, and an Ethernet or wireless network interface. The server executes an operating system such as a general-purpose server operating system and runs application software implemented in a scripting language such as a high-level interpreted language combined with a web application framework. The server further executes a machine learning runtime environment, such as a tensor-based numerical computation framework, to perform neural network inference and training.

The server stores merchandise information, user information, inquiry information, evaluation information, and generated proposal information in a structured data storage such as a relational database management system. The server stores model parameters, token vocabularies, and prompt templates in a persistent storage device. The server maintains an internal data schema including at least a merchandise table, a listing table, an inquiry table, a review table, a proposal table, and a strategy table. Each table has defined fields, for example, the merchandise table includes fields for identification information, attribute information, price information, and status information. The listing table includes fields for listing display information and display layout information identifiers.

The terminal operates as a client device such as a smartphone, a tablet, or a personal computer. The terminal executes a web browser or a dedicated application to present user interfaces generated by the server. The terminal transmits user input to the server through a network using a secure protocol. The terminal receives HTML-based screens or structured data from the server and renders listing display screens, configuration screens, and management screens. The terminal does not perform complex model inference but performs local validation and user interaction.

The user operates the terminal to access seller functions. The user registers merchandise information by entering at least identification information such as a code into an input field. The terminal transmits this identification information to the server. The server queries a merchandise data storage or an external catalog service by using the identification information as a key. The server retrieves merchandise attribute information such as category, dimensions, material, supported devices, and default description segments. The server supplements the original merchandise information with the retrieved attributes and stores the supplemented merchandise information in the merchandise table.

The server uses the supplemented merchandise information to construct a prompt sentence for a generative AI model. The server concatenates fixed instruction segments and dynamic content segments in accordance with a prompt template. For example, the server may generate a prompt sentence such as:
“Generate a concise and appealing product description for the following item. Specifications: waterproof, shock-resistant, compatible with multiple smartphone models. Emphasize everyday usability and durability. Output in English, within 200 words.”

The server formats the prompt sentence as a sequence of tokens according to a tokenizer associated with the generative AI model. The server encodes the prompt sentence and associated merchandise attributes into a data structure such as a sequence of integer token identifiers and positional encodings. The server then inputs this data structure into a neural network model implemented as a transformer-based generative AI model. The neural network model comprises multiple self-attention layers, feed-forward layers, and layer normalization operations. The model parameters are stored as weight matrices and bias vectors for attention heads and feed-forward sublayers.

The server executes the generative AI model in an inference mode using a machine learning runtime such as the above-mentioned numerical computation framework. The server performs numerical operations including matrix multiplications, non-linear activation functions, and softmax operations on a processor or an accelerator such as a graphics processing unit. The server generates output token probabilities for each decoding step and selects output tokens using a decoding strategy such as greedy decoding or beam search. The server assembles the selected tokens into a generated description sentence. The server decodes the token sequence into text and stores the resulting description in the listing table as part of the listing display information. The server selects display layout information for the merchandise item by analyzing the merchandise attribute information and applying a rule set or a trained classifier. The server, for example, selects a layout type for devices, apparel, or accessories based on the category. The server uses a template engine executed in the application layer to combine listing display information, including the generated description and images, with the selected display layout information. The server produces structured markup for the listing display screen. The terminal receives the generated screen and displays it, enabling the user to preview and confirm the listing.

The server processes inquiry information submitted by a buyer through a purchaser terminal. The terminal transmits inquiry text and a listing identifier to the server. The server stores the inquiry text in the inquiry table and performs preprocessing. The server applies a tokenizer to convert the inquiry text into token identifiers and may augment the input with special tokens to mark boundaries between inquiry text and merchandise context. The server then processes the tokenized inquiry using a classifier model or a shared encoder component of the generative AI model. The classifier model may be implemented as a transformer encoder, a bidirectional recurrent network, or a convolutional sequence network. The classifier model outputs a vector representation and class probabilities for possible intents such as product specification questions, compatibility questions, shipping questions, or price questions.

The server interprets the intent classification results by selecting the class with the highest confidence and applying threshold-based rules. The server may also extract key entities such as device model names or feature keywords using an auxiliary sequence labeling model or attention-based span extraction. The server then constructs a response-oriented prompt sentence that includes the classified intent, extracted entities, relevant merchandise attribute information, and a role instruction. For example, the server may generate a prompt sentence such as:
“You are a support assistant. Answer the following buyer question based only on the given product information. Product information: waterproof smartphone case, supports multiple recent smartphone models. Buyer question: ‘Is this case waterproof?’ Provide a short and clear answer.” The server encodes this prompt sentence and related context into token representations and feeds them into the generative AI model. The server performs decoding operations to generate an automatic response sentence. The server optionally constrains the decoding length and filters tokens based on allowed vocabulary categories to reduce hallucination and improve precision. The server decodes the generated tokens to text and stores the automatic response sentence in the inquiry table linked to the original inquiry. The server transmits the automatic response sentence to the purchaser terminal and, if configured in semi-automatic mode, also to the seller terminal for confirmation. This architecture enables the server to apply a uniform generative model while controlling behavior through prompt sentence construction and post-processing rules, which improves reliability and minimizes manual scripting of response patterns.

The server aggregates evaluation information such as reviews and ratings. When a purchaser submits a review via a purchaser terminal, the terminal sends review text, rating values, and associated identifiers to the server. The server stores this review data in the review table with timestamps. The server executes a batch analysis module at defined intervals. The server loads a batch of review records from the review table and preprocesses each review by tokenizing, normalizing, and filtering stop-words. The server transforms each review into a vector representation using a neural embedding model such as a sentence encoder or a pooled transformer representation.

The server then applies one or more downstream models implemented in the machine learning runtime. For example, the server may use a sentiment analysis model trained with a cross-entropy loss function on labeled review datasets. The sentiment model outputs a probability distribution over sentiment labels. The server may also use a topic classification model that outputs probabilities over interest items such as durability, price, design, and usability. The server aggregates predictions across reviews by computing weighted averages and counts per interest item. The server measures emotional tendency and evaluation tendency by computing metrics such as average sentiment score per interest item and frequency of negative mentions. The server uses these aggregated metrics to construct structured analysis summaries. The server defines a schema that includes fields such as interest item, positive ratio, negative ratio, representative review excerpts, and suggested direction of change. The server stores analysis summaries in the proposal table as intermediate data. The server then generates a prompt sentence for the generative AI model that encapsulates the structured analysis. For example, the server may generate a prompt sentence such as:
“Based on the following review analysis, propose concrete product improvements and a recommended price adjustment. Analysis: durability is frequently mentioned as weak at the corners; price is often described as slightly high; design is generally praised. Provide actionable suggestions.”

The server feeds this prompt sentence and a compact representation of the analysis summary as input to the generative AI model. The server performs inference to generate proposal information comprising textual recommendations such as improving corner reinforcement or adjusting price within a specified range. The server stores the generated proposal information in the proposal table and marks it as pending. The server later presents the proposal information to the seller terminal on a management display screen.

The server then updates merchandise information or price information based on explicit confirmation from the user operating the seller terminal. When the user approves a suggestion, the terminal sends an approval signal containing a proposal identifier. The server retrieves the corresponding proposal information, applies transformation rules to convert recommended values into structured updates, and writes updated price or attribute values to the merchandise table. The server triggers regeneration of the listing display information if descriptive content should be updated. This cycle allows the server to continuously refine merchandise data and listing configuration based on data-driven analysis rather than static business rules.

The server also interacts with an external delivery service information processing apparatus. The server receives transaction information that includes order identifiers and destination information. The server constructs control information messages formatted according to an application programming interface specification exposed by the delivery service system. The control information includes shipment items, weights, and address data. The server transmits the control information through a network interface. The server receives delivery identification information such as a tracking number from the delivery service. The server generates delivery display information that includes the delivery identification information and, optionally, a machine-readable representation such as a code string. The server stores the delivery identification information in the listing or transaction-related tables and updates delivery status fields as the shipment progresses. The seller terminal displays these details, and the user can confirm shipment operations. By integrating external apparatus control through structured messages, the server reduces manual data entry and mitigates errors in shipment identifiers. The server implements multiple internal modules to achieve technical improvements. For instance, the server segregates prompt construction, model inference, and post-processing into distinct software components, each with defined interfaces. The server processes textual and structured data using a common in-memory representation, such as JSON-like objects and typed records, to minimize conversion overhead. The server caches intermediate embeddings and model outputs for frequent queries, reducing redundant inference and improving response time. The server also uses batched inference for multiple inquiries or reviews by combining multiple tokenized sequences into a batch tensor, thus improving computational efficiency on accelerators.

The server implements non-trivial decision logic that differs from simple human workflow automation. For example, the server applies adaptive prompt templates based on classification results, uses confidence thresholds and similarity scores to select between template-based replies and generative replies, and invokes different generative model heads or decoding strategies depending on the length constraints and required formality. The server dynamically adjusts decoding parameters such as temperature and maximum token length based on task type (listing generation, short answer, strategy summary). This dynamic selection reduces unnecessary generation length, decreases network usage, and yields more consistent outputs tailored to each subtask.

The user benefits from technical effects such as reduced latency in generating listing pages and responses, increased accuracy of intent recognition in inquiries, and improved precision of improvement proposals derived from large volumes of historical data. The server achieves these technical effects by leveraging specialized model architectures trained with objective functions such as cross-entropy loss for classification and language modeling loss for text generation, by using training procedures including mini-batch gradient descent, adaptive optimizers, and regularization methods such as dropout. The server can also apply data augmentation for model training, for example by paraphrasing reviews or injecting synthetic noise to improve robustness to misspellings and colloquial expressions.

In an alternative embodiment, the server uses separate models for listing generation, inquiry response, and review analysis. The server may implement a smaller transformer model for inquiry classification to reduce inference time on short texts, and a larger autoregressive model for generating long-form listing descriptions. The server may also use a recurrent neural network or a convolutional network for sentiment classification where computational resources are limited. In another embodiment, the server uses a pre-trained generative AI model hosted on an external model serving system and communicates via an application programming interface. The server, in this case, focuses on prompt sentence construction, response validation, and integration with local databases, while offloading core inference to the external environment.

In yet another embodiment, the server adapts model behavior through feedback collection. The server records whether the user accepts or edits generated descriptions and responses, and the server stores these decisions in a feedback table. The server then periodically retrains internal models or fine-tunes prompt templates based on acceptance rates and edit patterns. For instance, if generated descriptions are often shortened by users, the server adjusts prompt sentences to request more concise text. This feedback-driven adaptation constitutes a technical improvement in system behavior, achieved through automated adjustment of model control parameters and prompt wording, without requiring manual reprogramming of rule-based logic.

The server thus improves computer technology by introducing a unified, prompt-driven architecture for generative AI model control, structured data management, and external apparatus interaction, rather than merely automating human tasks. The server reduces the amount of human-authored code required to handle variable natural language content, while at the same time providing stable interfaces and resource-efficient processing flows. By coordinating database operations, neural network inference, and network communication in a tightly integrated fashion, the server enhances throughput, reduces response times, and increases the accuracy and consistency of commerce-related content generated and managed by the computing system.

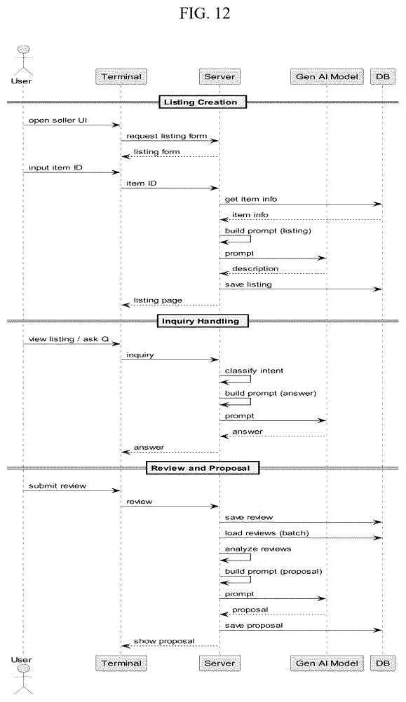

The following describes the processing flow using FIG. 12.

### Step 1:

User operates the terminal to open a seller interface for registering merchandise.

Terminal sends a request to the server to obtain an input screen. The input of this step is a screen request event from the user, and the output is a rendered input screen containing at least a field for identification information.

Server responds with a listing registration screen including input fields for an identification code and optional basic attributes. The server generates this screen by reading layout templates from storage and embedding control elements, then outputs HTML or structured UI data to the terminal.

### Step 2:

User inputs identification information, such as a merchandise code, into the terminal.

Terminal performs basic client-side validation (for example, length and character type checks) as data processing on the input string, and the input of this step is the raw code typed by the user. The terminal outputs normalized identification information (for example, trimmed and formatted code) and transmits it to the server in a request payload.

### Step 3:

Server receives the identification information and supplements merchandise information.

The input of this step is the identification information from the terminal. Server queries a merchandise data storage or an external catalog service using this identifier as a key, executes a database lookup or remote API call, and retrieves attribute records containing category, specifications, and default description fragments. Server then performs data merging operations: it combines user-provided fields and retrieved attributes into a unified merchandise record, resolves conflicts, and normalizes units and formats. The output is supplemented merchandise information stored in the merchandise table and held in memory for subsequent processing.

### Step 4:

Server constructs a prompt sentence for generating listing display information.

The input of this step is the supplemented merchandise information (for example, category, core features, and intended use). Server executes a template engine that maps structured attributes to natural language segments and concatenates them with fixed instruction text to build a prompt sentence. As a concrete example, the server may generate:
“Generate an appealing and concise product description for the following item. Category: protective smartphone accessory. Key features: waterproof, shock-resistant, slim design. Emphasize everyday usability and durability. Output in English within 200 words.” Server outputs a finalized prompt sentence as a tokenizable text string.

### Step 5:

Server encodes the prompt sentence and executes inference on a generative AI model to produce a listing description.

The input of this step is the prompt sentence from Step 4. Server applies a tokenizer to convert the prompt into a sequence of token identifiers and positional indices. Server constructs a tensor representing the token sequence and feeds it into a transformer-based generative AI model loaded in a machine learning runtime. The server performs numerical data processing including matrix multiplications in self-attention layers and feed-forward layers, computes token probability distributions at each decoding timestep, and selects output tokens with a decoding algorithm such as greedy decoding or beam search. The output is a generated description text representing the listing display information, which the server decodes from tokens and stores in the listing table.

### Step 6:

Server selects display layout information and constructs a listing display screen.

The input of this step is the generated description text and the supplemented merchandise information. Server evaluates category and attribute flags and applies a ruleset or a classifier to determine an appropriate layout type (for example, “device-accessory layout”). Server then executes a template engine that injects title, generated description, price field placeholders, and image references into a layout template. The data processing in this step combines structured fields and text into a markup structure. The output is a complete listing display screen definition, which the server returns to the terminal for rendering.

### Step 7:

User reviews and optionally edits the generated listing on the terminal.

The input of this step is the rendered listing screen with generated content. User may change the suggested price, adjust wording, or add images. Terminal captures these edits as structured update data (for example, new price, edited text, uploaded file references). The output of this step is updated listing information, which the terminal transmits to the server.

### Step 8:

Server validates and stores the updated listing information and activates the listing.

The input is the updated listing data from the terminal. Server performs validation computations, such as checking numeric ranges for price and verifying that required fields are non-empty. Server then writes the finalized price and text into the merchandise and listing tables and sets a status flag to “active.” The output is an activated listing record with unique identifiers, which server makes available for buyer access.

### Step 9:

Purchaser uses a terminal to view the listing and submit an inquiry.

The input of this step is the active listing display screen served by the server. Purchaser enters a question such as “Is this case compatible with the latest model?” into an inquiry field. Terminal packages this inquiry as text plus listing identifier and sends it to the server. The output is inquiry information forwarded to the server for processing.

### Step 10:

Server preprocesses inquiry information and classifies inquiry intent.

The input is inquiry text and associated metadata (listing ID, timestamp). Server normalizes the text (lowercasing, punctuation handling), tokenizes it into subword units, and constructs a token sequence tensor. Server then feeds this tensor into an intent-classification model, for example a transformer encoder, which computes hidden representations and outputs class probability scores for intent categories such as compatibility, specification details, shipping, or price. The server applies argmax selection and confidence thresholding as data operations. The output is a predicted intent label and, optionally, extracted key entities.

### Step 11:

Server constructs a response-oriented prompt sentence based on inquiry analysis and merchandise information.

The input is the predicted intent, extracted entities, and merchandise attributes associated with the listing. Server selects a prompt template corresponding to the intent type and fills placeholders with specific attribute values and the original question. For example, server may generate:
“You are a customer support assistant. Answer the buyer's question using only the following product information. Product information: protective case, compatible with smartphone models A, B, and C, waterproof rating IPX7. Buyer question: ‘Is this case waterproof?’ Provide a short and accurate answer.”

Server outputs this response-oriented prompt sentence for use by the generative AI model.

### Step 12:

Server generates an automatic response sentence using the generative AI model.

The input is the response-oriented prompt sentence. Server tokenizes the prompt, generates embedding vectors, and feeds them into the generative AI model. The server performs forward passes through attention and feed-forward layers, computing next-token distributions at each step. Server constrains decoding length and, if needed, applies token filtering rules (for example, forbidding unsupported claims). The output is a response sentence such as “Yes, this case is waterproof and suitable for everyday exposure to rain,” which server decodes to text and stores in the inquiry table.

### Step 13:

Server delivers the automatic response to purchaser and, optionally, to the seller for confirmation. The input is the generated response sentence and the inquiry identifier. Server updates the inquiry record with response content and status, and then formats a message to the purchaser terminal. If semi-automatic mode is enabled, server also sends the response to the seller terminal and awaits a confirmation flag. After confirmation or immediately in full-automatic mode, the server outputs the response to the purchaser terminal, where the terminal renders the answer in a conversation view.

### Step 14:

Purchaser submits evaluation information via the terminal after receiving the merchandise.

The input of this step is a review screen including rating controls and a text box. Purchaser enters a rating and review text, such as “The case is waterproof but the corners cracked after two weeks.” Terminal performs local checks (for example, required fields, length limit) and outputs evaluation information consisting of rating value, text, and listing identifier, which it transmits to the server.

### Step 15:

Server stores evaluation information and prepares data for batch analysis.

The input is evaluation information from the terminal. Server writes review text, rating, and metadata into the review table with a timestamp. Server also updates aggregated counters such as review count per listing. The output of this step is a persistent set of review records and updated aggregate statistics, which are later consumed by analysis routines.

### Step 16:

Server executes batch analysis of accumulated evaluation information to compute emotional and evaluation tendencies.

The input is a collection of review records selected by time range or listing. Server preprocesses each review by tokenizing, normalizing, and converting to embedding vectors via a sentence encoder. Server then feeds these embeddings into a sentiment model and a topic model implemented in the machine learning runtime. The sentiment model outputs probabilities for positive, neutral, and negative sentiment; the topic model outputs probabilities per interest item such as durability or price. The server aggregates these outputs by computing averages and counts for every interest item. The output is a structured analysis summary including emotional tendencies and evaluation tendencies for each interest item.

### Step 17:

Server generates a prompt sentence for improvement and price adjustment proposals based on the analysis summary.

The input is the structured analysis summary (for example, high negative sentiment on durability, moderate negative sentiment on price). Server maps these metrics to textual summary segments and inserts them into a proposal prompt template. Server may generate, for instance:
“Based on the following review analysis, propose specific improvements and a price adjustment. Analysis: many users report that the corners of the case crack within two weeks; several users mention that the price feels slightly high; design quality is praised. Suggest concrete material or structural changes and a recommended price range.”

The output is a proposal-oriented prompt sentence ready for generative processing.

### Step 18:

Server invokes the generative AI model to produce proposal information.

The input is the proposal-oriented prompt sentence. Server tokenizes and encodes this prompt, executes the generative AI model to generate multi-sentence output containing recommended design changes, quality improvements, and price adjustments. Server may use beam search to improve coherence and apply post-processing to segment the output into bullet-like recommendations. The output is proposal information stored in the proposal table and labeled with the associated listing or merchandise identifier.

### Step 19:

Server presents proposal information to the seller terminal in a management display screen. The input is stored proposal information and associated listing identifiers. Server constructs a management view that groups proposals by merchandise item and strategy type. Server formats proposal titles, summaries, and detailed texts, and transmits this view definition to the seller terminal. The output is a rendered management display screen on the terminal, showing, for example, “Strengthen corner material” and “Decrease price by approximately 10-15%.”

### Step 20:

User reviews and selects proposals to apply using the seller terminal.

The input is the management display screen containing multiple proposals. User reads the suggestions and decides whether to accept or reject each one. Terminal captures the user's decisions as structured input (for example, proposal ID and action “accept” or “reject”). The output is a set of decision commands sent back to the server.

### Step 21:

Server updates merchandise and listing records based on accepted proposals and regenerates listing display information.

The input is the set of decision commands. Server parses each command, retrieves corresponding proposal information, and applies transformation rules to derive specific updates, such as a new price value or a revised feature list. Server updates the merchandise table and listing table accordingly and flags the listing for regeneration. Server then re-executes the listing generation pipeline, possibly using a new prompt sentence reflecting updated attributes, and outputs updated listing display information to be rendered on purchaser terminals.

### Step 22:

Server generates and manages delivery-related information by interacting with an external delivery service information processing apparatus.

The input is transaction information including purchased items and destination information. Server constructs control information messages with item details and destination data, performs serialization into the required protocol format, and transmits the messages to the external apparatus. Server receives delivery identification information such as tracking numbers, then executes data operations to associate these identifiers with the corresponding transaction and merchandise records. The output is delivery display information containing tracking data, which server sends to the seller terminal for display and uses to update delivery status fields as further status messages are received.

### Step 23:

Server logs interactions and feedback to refine prompt strategies and model usage.

The input is operational data including user edits of generated texts, acceptance or rejection of proposals, response times, and error conditions. Server stores this operational data in a feedback table and periodically analyzes it to optimize prompt templates and decoding parameters. Server may adjust prompt wording, maximum token lengths, or model selection logic based on observed acceptance rates. The output is an updated set of prompt templates and model control parameters stored in configuration data, which the server uses in subsequent executions to improve accuracy, reduce latency, and lower processing and communication overhead.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional network-based commerce systems generally require a seller to manually search for product information, manually compose listing content, and manually manage communications, delivery updates, and review analysis through separate tools or interfaces. This fragmented processing causes several technical problems in the underlying computer system. First, because product information retrieval, listing generation, messaging, logistics tracking, and review analysis are implemented as isolated modules or external applications, the server must perform multiple redundant data conversions and database accesses, which increase processor load, network traffic, and storage operations. Second, conventional systems do not provide a structured mechanism for transforming unstructured evaluation text into machine-usable improvement proposals within the same computational pipeline, so the server cannot effectively use text data to optimize internal data structures such as pricing parameters or listing configurations. Third, existing systems typically treat user reviews and communications as passive data stored in a database, without integrating a generative AI model through controlled prompt sentences, resulting in inefficient utilization of processing resources and requiring a human operator to manually interpret and act on the data. As a result, the overall throughput of the server, the latency for generating listings and responses, and the scalability of the platform are degraded, and the computer system cannot automatically adapt listings based on real-time feedback.

The technical problem addressed by the invention is to improve the functioning of a network-based data processing system by (i) unifying product information acquisition, listing generation, communication handling, delivery management, and review-based optimization into a coordinated server-side control flow, (ii) enabling the processor to programmatically construct prompt sentences and interact with generative AI models and emotion analysis models in a way that directly updates internal data representations such as listing records and recommendation records, and (iii) reducing manual intervention and duplicated processing while increasing the efficiency, consistency, and responsiveness of the server when handling large volumes of product-related transactions and user interactions.

The specific processing by the specific processing unit 290 of the data processing device 12 in Example 2 is realized by the following means.

The present invention provides a server comprising a processor configured to acquire product identification information from a terminal, communicate with an external information provision apparatus based on the product identification information, and acquire product attribute information; to automatically generate listing information data based on the product attribute information, to set a price information input region in the listing information data, and to construct listing display data; to associate and store price information received from the terminal with the listing information data and generate a sales publication screen; to acquire inquiry information from a prospective purchaser, to select response candidate information according to an inquiry type, to generate automatic response information, and to transmit the automatic response information to the terminal; to acquire delivery identification information and delivery status information, to update delivery management information based on the delivery status information, and to transmit delivery notification information to a seller and the prospective purchaser; to acquire evaluation text information stored in an evaluation information storage unit, to generate input data including a prompt sentence describing that the evaluation text information is to be summarized and that a product improvement plan and a price adjustment plan are to be generated, to provide the input data to a generative information processing model to obtain the product improvement plan and the price adjustment plan, and to store and present an output result from the generative information processing model as proposal information for the seller; and, in some embodiments, to acquire text data input by a user, to generate input data including a prompt sentence describing that an emotional state is to be estimated from the text data, to provide the input data to an emotion analysis information processing model to obtain emotion evaluation information, and to adjust content or a presentation method of the product improvement plan and the price adjustment plan based on the emotion evaluation information. This enables the server to implement an integrated and automated data processing pipeline in which product attributes are retrieved and normalized, listing records and communication records are generated and updated, delivery status is tracked and notified, and unstructured evaluation text is transformed via generative AI and emotion analysis models into structured improvement plans that directly modify or guide listing configuration and pricing, thereby reducing redundant processing, improving resource utilization, lowering response latency, and enhancing the overall technical performance and scalability of the network-based commerce system.

The term “processor” refers to a hardware or virtual computation unit, such as a central processing unit or a processing core of a computing apparatus, that executes machine-readable instructions to perform the functions described in the claims.

The term “terminal” refers to an information processing device operated by a user, such as a client computer, a mobile communication device, or another user interface device, that transmits input data to and receives output data from the server.

The term “product identification information” refers to data for uniquely or specifically identifying an item, such as a standardized code, a catalog number, or another identifier used to retrieve product-related information.

The term “external information provision apparatus” refers to a remote information processing system, such as a network-accessible data service or database system, that responds to a request by returning product-related data.

The term “product attribute information” refers to structured data describing characteristics of an item, including at least one of a name, a creator, a release date, a category, a description, or other attributes used for listing and selling the item.

The term “listing information data” refers to structured data used by the server to represent an offer for sale of an item, including at least the product attribute information and metadata required to generate a display for a sales listing.

The term “price information input region” refers to a defined data field or user interface element allocated in the listing information data or listing display data, into which price-related information can be entered or updated.

The term “listing display data” refers to data defining contents of a display screen or web page that presents an offer for sale of an item, including product attribute information, price information, and layout information.

The term “price information” refers to data representing a monetary amount or pricing condition associated with a listing, including at least a selling price for an item.

The term “sales publication screen” refers to a display or web page generated by the server and provided to terminals of potential purchasers, the display or web page showing a listing that is available for purchase.

The term “prospective purchaser” refers to a user or entity that accesses a listing and may decide to purchase the corresponding item, including any client device acting on behalf of such user or entity.

The term “inquiry information” refers to message data transmitted from a terminal of a prospective purchaser to the server, the message data including text or other content requesting information or action with respect to a listing or transaction.

The term “response candidate information” refers to one or more predefined or dynamically generated response patterns or templates that can be selected by the processor to form automatic response information.

The term “automatic response information” refers to response message data generated by the processor without direct manual composition by a human operator at the time of reply, based on at least the inquiry information and the response candidate information.

The term “delivery identification information” refers to data for identifying a delivery or shipment, including at least one of a tracking number, a shipment identifier, or another code associated with a logistics process.

The term “delivery status information” refers to data representing a current or past state of a shipment, including at least one of dispatched, in transit, delayed, or delivered status data.

The term “delivery management information” refers to structured data maintained by the server that associates a delivery with its identification information, delivery status information, and related order or listing records.

The term “delivery notification information” refers to message data generated by the server and transmitted to a seller or a prospective purchaser to inform them of a status or change of status of a delivery.

The term “evaluation information storage unit” refers to a logical or physical storage component, such as a database or storage area, in which evaluation text information and related metadata are stored.

The term “evaluation text information” refers to text data representing feedback, reviews, comments, or ratings provided by users with respect to items, listings, or transactions.

The term “input data” refers to data prepared by the processor for submission to an information processing model, the data including at least one prompt sentence and optionally additional parameters or context information.

The term “prompt sentence” refers to a natural-language or structured instruction string included in the input data, which specifies a task or operation to be performed by an information processing model, such as summarization, plan generation, or emotion estimation.

The term “generative information processing model” refers to a machine-learned model, such as a generative AI model, that outputs generated text or structured data in response to input data including a prompt sentence.

The term “product improvement plan” refers to generated content describing suggested modifications or enhancements to at least one aspect of an item, its presentation, or its related services, based on analysis of evaluation text information or other data.

The term “price adjustment plan” refers to generated content describing suggested changes to pricing, discounts, or pricing strategy of an item, based on analysis of evaluation text information or other data.

The term “proposal information for the seller” refers to data presented by the server to a seller, including at least one of a product improvement plan or a price adjustment plan, for use in modifying listings or business decisions.

The term “emotion analysis information processing model” refers to a machine-learned model configured to estimate an emotional state or sentiment from text data or related input data.

The term “emotion evaluation information” refers to data representing an estimated emotional state, sentiment, or attitude of a user, as determined from text data by the emotion analysis information processing model.

The term “listing page configuration template” refers to a structural definition of a layout and field arrangement for a listing display, including positions or formats for product attribute information and price information.

The term “template selection rule” refers to one or more programmatically defined conditions or criteria used by the processor to select a listing page configuration template in accordance with at least one of a product type, attribute, or context.

The term “external information acquisition process” refers to a sequence of operations executed by the processor to communicate with the external information provision apparatus and to acquire product attribute information based on product identification information.

The term “analysis process of the product attribute information” refers to a sequence of operations executed by the processor to interpret, normalize, or categorize product attribute information provided from the terminal or acquired externally.

The term “sales listing record” refers to a data record maintained by the server that associates product attribute information, price information, status information, and identifiers for a particular listing offered for sale.

In one embodiment, a server includes a processor, a main memory, a non-volatile storage device, a network interface, and an interface to one or more database systems. The server executes an operating system such as a general-purpose server operating system and runs one or more application programs implemented, for example, using a web application framework such as a server-side framework, a scripting language runtime, and a database access library. A terminal operated by a user includes a processor, a display, an input device such as a keyboard or touchscreen, a memory, and a communication interface. The terminal executes a web browser or a native application that communicates with the server over a packet-switched network using a protocol such as HTTPS.

The server executes an application that exposes network-accessible interfaces for product listing management, communication management, delivery management, and evaluation analysis. The server stores product attribute information, listing information data, inquiry information, delivery management information, evaluation text information, and proposal information for the seller in one or more relational databases, such as a structured query language database, and optionally in an in-memory cache for high-frequency access.

The server acquires product identification information from the terminal and uses the product identification information as a key to query an external information provision apparatus. The external information provision apparatus is implemented as a remote server that exposes a programmatic interface such as a web service interface returning product attribute information in a structured format such as JavaScript Object Notation or Extensible Markup Language. The server uses an HTTP client library to construct a request message containing authentication parameters and the product identification information, transmits the request via the network interface, and receives a response message containing product attribute information such as item title, creator name, release date, and category code.

The server parses the response message using a JSON or XML parsing library and normalizes the parsed values into internal data structures. For example, the server stores the product attribute information in a product table having fields such as product_id, title, creator, release_date, category_code, and description. The server may store a mapping between the product identification information and the internal product_id to avoid repeated external calls for the same product. By caching normalized product attribute information, the server reduces repeated network communication and database writes, thereby improving processing speed and reducing communication load.

The server automatically generates listing information data based on the product attribute information. The server applies a template selection rule that maps category_code or other product attributes to a listing page configuration template. For example, the server may select a template having predefined sections for title, creator, release date, and description when the category_code indicates a publication, or a different template when the category_code indicates a different goods group. The server constructs listing information data as a structured record including a reference to the product_id, a status field, a price information field, and layout meta-information indicating which product attributes are to be displayed in which regions of the listing display data.

The server sets a price information input region in the listing information data. Concretely, the server defines a field such as price_value and currency_code and associates those fields with a display widget definition in a template. The server transmits listing display data to the terminal, which renders a screen showing product attributes and an editable field for price. The user uses the terminal to input price information into the price information input region via the input device. The terminal transmits the price information to the server, and the server stores the price information in the corresponding listing record. The server then marks the listing record with a publishable status and generates a sales publication screen definition that includes both product attribute information and the newly registered price information.

The server exposes the sales publication screen via a web route or an application programming interface. A terminal operated by a prospective purchaser transmits a request for the sales publication screen. The server retrieves the listing information data from the database, combines it with product attribute information, and generates listing display data as a rendering description such as an HTML document or a structured layout description for a mobile application. The terminal renders the listing display data on the display to allow the prospective purchaser to view the product and the price.

The server acquires inquiry information from the terminal of the prospective purchaser. The terminal provides a user interface for inputting text, and the user enters inquiry text regarding the listing. The terminal transmits the inquiry text, along with identifiers such as a listing identifier and a user identifier, to the server. The server stores the inquiry information in an inquiry table and classifies the inquiry using a rule-based classifier or a lightweight machine-learned classifier. For example, the server can compute a term frequency-inverse document frequency representation of the inquiry text and compare it against pre-stored centroid vectors for typical inquiry types such as “request for more details,” “shipping question,” or “discount request.” The server assigns an inquiry type label to the inquiry information.

The server maintains response candidate information for each inquiry type. The response candidate information may include parameterized templates such as “Please see the listing page for detailed product information” for a detail request, or “The expected delivery period is X to Y days” for a shipping question. The server selects response candidate information based on the assigned inquiry type and generates automatic response information by inserting listing-specific parameters such as title or estimated delivery into the template. The server transmits the automatic response information to the terminal of the prospective purchaser. This automatic response reduces human intervention and, by storing and reusing templates and inquiry classifications, decreases processor load relative to free-form generation for each inquiry, thus improving processing efficiency and response latency.

The server acquires delivery identification information and delivery status information by interfacing with logistics systems. The seller uses the terminal to register that a shipment has been initiated and to input a tracking number and carrier code. The terminal transmits this delivery identification information to the server. The server stores a delivery record including fields for tracking_number, carrier_code, order_id, and delivery_status. The server periodically transmits status query messages to a logistics information provision apparatus, receives delivery status information, and updates the delivery_status field accordingly. The server then generates delivery notification information and transmits it to both seller and prospective purchaser terminals. This repeated polling and conditional notification logic is implemented as scheduled tasks or event-driven functions on the server, improving the coherence of delivery management information and reducing the need for the user to manually check multiple external sites, thus lowering network overhead and aggregating status information in a single optimized data structure.

The server acquires evaluation text information from terminals used by purchasers after completion of a transaction. A purchaser uses the terminal to input an evaluation, including a rating value and review text such as “This product is very good, but I would be happier if it were a little cheaper.” The terminal transmits this data to the server, which stores the review text and associated metadata in an evaluation information storage unit implemented as a database table with indexing on product_id and time. The server uses these indices to efficiently retrieve sets of evaluation text information for a particular product or time period.

The server generates input data including a prompt sentence for a generative information processing model. In one embodiment, the generative information processing model is implemented as a large-scale neural network of the transformer type. The neural network includes multiple self-attention layers, feed-forward layers, and layer normalization components. The server does not merely call a black-box model; instead, the server constructs specific prompt sentences and auxiliary tokens that control the behavior of the model. For example, the server concatenates a header instruction with a list of reviews and explicit output constraints. A prompt sentence example is:
“Please analyze the following reviews and propose product improvements and price adjustment suggestions:
1) ‘This product is very good, but I would be happier if it were a little cheaper.’
2) ‘The quality is excellent, but the price feels slightly high.’

Summarize the main issues in bullet points and suggest concrete actions for the seller.”

In another example, the server constructs a prompt sentence targeted at a single review:
“Please analyze the following review and propose improvements to the product: ‘This book was very interesting, but I felt that the price was a bit high.’”

The server includes such a prompt sentence in input data that may further include control parameters such as a maximum token count, a sampling temperature, and a top-k cutoff. The server transmits the input data to the generative information processing model via an application programming interface.

The generative information processing model operates on tokenized representations of the prompt sentence and evaluation text information. In one embodiment, the model uses byte-pair encoding to transform text into discrete token indices. The model then applies multi-head self-attention to compute contextual embeddings for each token. The model parameters include weight matrices for attention projections, feed-forward networks, and layer normalizations. The model has been pre-trained on a large text corpus using a next-token prediction objective that minimizes cross-entropy loss between predicted token distributions and actual tokens. During this pre-training, the model updates its parameters using an optimization algorithm such as Adam, computing gradients of the loss function via backpropagation and adjusting weights to reduce prediction error. Optionally, the model may be fine-tuned on domain-specific data containing product reviews and pricing suggestions to refine its behavior.

The model computes output token sequences representing generated text that includes a product improvement plan and a price adjustment plan. For example, the model can output text such as:
“The content quality is praised, but the price is perceived as high. Consider lowering the price by 10-20% or adding additional value such as supplementary materials or extended support to justify the current price.”

The server receives the generated token sequence, decodes it into text using the inverse of the tokenization process, and stores the result as proposal information for the seller in a structured form. The server may segment the generated text into structured fields such as improvement points and price_suggestions by applying heuristic rules, pattern matching, or a secondary classifier that detects bullet points and key phrases. This structured storage enables efficient indexing and retrieval of proposals across many products and time periods, which directly improves the data management capabilities of the system.

The server, in some embodiments, acquires text data input by a user, such as free-form feedback from a seller or a purchaser, and generates input data for an emotion analysis information processing model. The server constructs a prompt sentence such as:
“Please estimate the emotional state expressed in the following text and return a label among {positive, neutral, negative}: ‘This product was very interesting, but I felt that the price was a bit high.“ ”

The server includes the text data and the prompt sentence in input data for the emotion analysis information processing model. The emotion analysis model may be a transformer-based classifier fine-tuned on sentiment-labeled corpora. The model architecture includes an encoder that maps input tokens to contextual embeddings and a classification head that computes a probability distribution over emotion labels. The model is trained using a cross-entropy loss between predicted label distributions and true labels, and parameters are updated via gradient descent. The server interprets the resulting emotion evaluation information, such as a high probability for a mixed-positive-but-price-sensitive label, and adjusts the content or presentation method of the product improvement plan and the price adjustment plan. For example, the server may emphasize pricing changes when the emotional state indicates price dissatisfaction, or prioritize quality improvements when the emotional state indicates dissatisfaction with functionality. The combination of generative and emotion analysis models in this architecture results in technical effects that go beyond simple automation of human reasoning. Because the server uses structured prompt sentences, token-level control parameters, and downstream structured storage, the server can systematically transform unstructured evaluation text information into normalized proposals that directly update internal database records such as recommended price fields or listing_description templates. This integration allows the server to perform batch processing and incremental updates, to cache intermediate embeddings if the same review appears in multiple contexts, and to reduce the number of full recomputations needed when new reviews are added. As a result, the server reduces the computational complexity of repeated analyses, improves throughput, and reduces latency for generating updated proposals as the dataset grows.

The server adopts specific data structures and algorithms that further improve technical performance. For example, the server stores evaluation text information with inverted indices on token stems, enabling rapid retrieval of reviews related to pricing or quality issues. The server uses a queue-based architecture for submitting prompt sentences to the generative information processing model, allowing concurrent processing of multiple products while enforcing rate limits and retry policies. The server may pre-compute and cache vector embeddings of reviews using a separate embedding model, and then cluster these embeddings to identify representative reviews, thereby reducing the length of prompt sentences and lowering token processing costs. This design directly reduces communication load between the server and the external generative information processing system and decreases computational load within the model by shortening inputs without substantially decreasing the accuracy of proposals.

AI-based processing in this system is not limited to a mere replacement of human decision-making; instead, it leverages representations, token-level operations, and algorithmic flows that are not practically implementable by human operators at similar scale or speed. The server can, for example, process thousands of reviews per product, cluster them in a high-dimensional vector space, and generate composite prompt sentences that are optimized for diversity and representativeness of issues. The server can also adaptively tune prompt sentences based on feedback loops: when generated proposals consistently lead to subsequent positive evaluations, the server can log such cases and bias future prompt constructions toward patterns that historically yielded beneficial outcomes.

The server, terminal, and user cooperate in multiple alternative embodiments. In one alternative, the terminal executes part of the pre-processing and post-processing for prompt sentences, such as local tokenization or emotion keyword highlighting, to offload computation from the server and reduce network bandwidth by transmitting compressed or encoded representations. In another alternative, the server hosts an internal generative information processing model within its own computing environment instead of or in addition to using an external model. In that case, the server loads a trained model, stores its parameters in high-speed memory such as graphics processor memory or specialized accelerator memory, and executes inference routines locally. The server can then adjust low-level inference parameters such as beam width or sampling strategies to further optimize latency and throughput.

In yet another embodiment, the server dynamically selects between different generative information processing models or different prompt patterns based on product category, historical model performance, or available computational resources. For example, the server may use a smaller model with lower latency for real-time interaction scenarios and a larger model with higher accuracy for batch overnight analysis of large review sets. The server may also adapt the template selection rule based on outcomes: if listings generated by a certain template yield better conversion rates after application of AI-generated suggestions, the server increases the probability of choosing that template for similar products in the future.

Because the server maintains all these data structures and AI-based analyses within a single integrated system, the invention improves computer technology itself. The server reduces duplicated data acquisition by caching normalized product attributes, decreases redundant parsing by centralizing product attribute normalization, reduces network traffic by aggregating external API calls and model calls into batch operations, and optimizes memory usage by storing embeddings and structured proposals instead of repeatedly processing raw text. The server's coordinated management of listing generation, communication, delivery tracking, and evaluation-driven optimization yields lower end-to-end latency and higher throughput for large-scale online listing operations than conventional systems that implement each function as an isolated module with ad hoc human supervision.

The described embodiments are illustrative and not limiting. The server may use different database technologies, different neural network architectures for the generative information processing model and the emotion analysis model, different tokenization schemes, or different optimization algorithms. The terminal may be implemented as a web client, a mobile application, or a dedicated appliance. Variations in model size, training data, and hyperparameters may be employed to adapt the system to particular deployment environments while preserving the core interaction between product identification, listing generation, communication handling, delivery management, and evaluation-based optimization using prompt sentences and generative AI models.

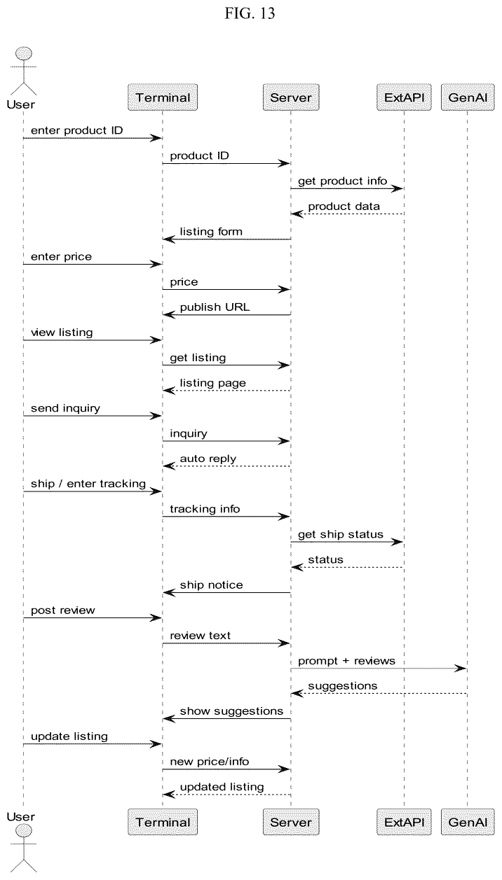

The following describes the processing flow using FIG. 13.

### Step 1:

User operates the terminal to input product identification information (for example, a standardized product code) into an input field displayed on the screen.

Terminal receives the product identification information as character data, performs basic client-side validation (such as checking that the length and character set are valid), and transmits the product identification information to the server via an HTTP request.

The input of this step is the product identification information entered by the user, and the output is a network request message containing the product identification information that is delivered to the server.

### Step 2:

Server receives the network request containing the product identification information through a network interface and parses the request using a web framework.

Server validates the product identification information (for example, checks format, length, and checksum rules) and logs the request into an application log.

Server uses the validated product identification information as input to generate an external API request, including authentication parameters and query parameters, and transmits this request to an external information provision apparatus.

The input of this step is the validated product identification information, and the output is an external service request that is sent to the external information provision apparatus.

### Step 3:

Server receives a response from the external information provision apparatus containing product attribute information in a structured format such as JSON or XML.

Server parses the response body using a parser library, extracts fields such as title, creator, release date, category code, and description, and normalizes them into internal key-value pairs.

Server stores the normalized product attribute information in a product table in a database and creates or updates a mapping between the product identification information and an internal product identifier.

The input of this step is the structured response from the external information provision apparatus, and the output is a set of normalized product attribute records stored in the server's database.

### Step 4:

Server generates listing information data based on the stored product attribute information.

Server applies a template selection rule using at least one product attribute (for example, category code) to select a listing page configuration template from a template repository.

Server constructs listing information data as a data object that includes references to the selected template, the internal product identifier, default status flags, and empty or default price information fields.

The input of this step is the normalized product attribute information and the template selection rule, and the output is a listing information data object that is ready to be presented to the user.

### Step 5:

Server transforms the listing information data into listing display data appropriate for the terminal, for example, HTML markup or structured JSON describing UI components.

Server embeds product attributes into designated regions within the selected template, defines a price information input region, and sends the resulting listing display data to the terminal via an HTTP response.

The input of this step is the listing information data and the selected template structure, and the output is formatted listing display data transmitted to the terminal.

### Step 6:

Terminal receives the listing display data from the server and parses it using a browser engine or a UI framework.

Terminal renders the product attributes and an editable price information input field on the display, and may perform client-side formatting such as currency display.

User views the presented product information on the terminal and confirms that it matches the intended item.

The input of this step is the listing display data from the server, and the output is a rendered user interface on the terminal's display that allows the user to enter price information.

### Step 7:

User operates the terminal to input price information (for example, a numeric value and optionally a currency) into the price information input field and confirms the input using a submit control.

Terminal validates the format of the price information (for example, checks that it is numeric and within a valid range) and constructs a network request including the price information and the listing identifier.

Terminal transmits this network request to the server via an HTTP or HTTPS connection.

The input of this step is the price information entered by the user, and the output is a network request containing the price information and listing identifier delivered to the server.

### Step 8:

Server receives the network request containing the price information and listing identifier and parses it.

Server validates the price information (for example, verifies numeric format and adherence to business rules) and writes the validated price information into the corresponding listing record in the database.

Server updates the listing status field to indicate that the listing is ready for publication, and generates or confirms a public listing URL.

The input of this step is the validated price information and listing identifier, and the output is an updated listing record stored in the database and associated with a public listing URL.

### Step 9:

Server generates a sales publication screen definition based on the updated listing record and associated product attribute information.

Server merges product attributes, price information, images, and layout parameters into a final rendering structure and stores a reference to this structure for caching.

Server makes the sales publication screen accessible through a public endpoint, so that terminals operated by prospective purchasers can request it.

The input of this step is the updated listing record and product attribute records, and the output is a publishable sales screen configuration accessible by prospective purchasers.

### Step 10:

Terminal operated by a prospective purchaser sends a request for the sales publication screen to the server by accessing the public listing URL.

Server receives the request, retrieves the listing information data and product attribute information from the database, and constructs a current version of the sales publication screen.

Server returns the sales publication screen to the terminal, which then renders it for the prospective purchaser.

The input of this step is the public listing URL request from the terminal, and the output is the rendered sales publication screen displayed on the prospective purchaser's terminal.

### Step 11:

User, acting as a prospective purchaser, views the sales publication screen and may submit inquiry information through an inquiry form associated with the listing.

Terminal collects the inquiry text and associated metadata such as user identifier and listing identifier, and sends these as inquiry information to the server.

The input of this step is the inquiry text entered by the user on the terminal, and the output is a structured inquiry information message transmitted to the server.

### Step 12:

Server receives the inquiry information, stores it in an inquiry table, and performs text processing on the inquiry text.

Server tokenizes the inquiry text, may compute features such as term frequencies, and compares them against pre-defined patterns or classifier thresholds to determine an inquiry type category (for example, product details, shipping, or pricing).

Server uses the determined inquiry type as input to select response candidate information from a repository of response templates or patterns.

The input of this step is the inquiry information including inquiry text, and the output is a selected response candidate corresponding to an inferred inquiry type.

### Step 13:

Server generates automatic response information by combining the selected response candidate with listing-specific and user-specific data.

Server replaces placeholders in the template with concrete values such as product title, estimated shipping time, or current price and constructs a final response message.

Server transmits the automatic response information to the terminal of the prospective purchaser and records the response in the inquiry table for traceability.

The input of this step is the selected response candidate and contextual data from the listing and user records, and the output is a formatted automatic response message delivered to the terminal.

### Step 14:

Server receives delivery identification information (such as tracking number and carrier code) from a terminal operated by the seller when the seller initiates shipment.

Server stores a delivery record associating this delivery identification information with the corresponding order or listing and initializes a delivery status field.

Server transmits status queries to a logistics information provision apparatus based on the delivery identification information and receives delivery status information (for example, in-transit or delivered).

The input of this step is the delivery identification information provided by the seller and subsequent status responses from the logistics apparatus, and the output is updated delivery records with current delivery status values.

### Step 15:

Server updates delivery management information by writing the latest delivery status into the delivery record and optionally computing derived fields such as estimated remaining time.

Server generates delivery notification information addressed to both seller and prospective purchaser, including the updated status and optionally a link to detailed tracking information.

Server sends the delivery notification information to the terminals associated with the seller and the prospective purchaser via network communication methods such as email or push notifications.

The input of this step is the newly received delivery status information, and the output is updated delivery management records and transmitted delivery notifications.

### Step 16:

User, acting as a purchaser, after receiving and using the product, operates the terminal to input evaluation text information and a rating value into a review form associated with the listing. Terminal validates the input length and allowed characters, bundles the evaluation text information and rating value with identifiers for the product and user, and sends this evaluation data to the server.

The input of this step is the evaluation text and rating entered by the user, and the output is a structured evaluation data message transmitted to the server.

### Step 17:

Server receives the evaluation data and stores the evaluation text information and rating value in an evaluation information storage unit with indexes on product identifier and timestamp.

Server marks new evaluation records as pending analysis and may compute basic statistics such as average rating for immediate display.

The input of this step is the structured evaluation data from the terminal, and the output is normalized and indexed evaluation records stored for subsequent analysis.

### Step 18:

Server periodically or on demand selects evaluation text information for analysis, grouping multiple reviews for the same product when appropriate.

Server constructs a prompt sentence that instructs a generative AI model to summarize the evaluations and propose a product improvement plan and a price adjustment plan.

Server concatenates multiple review texts with the prompt sentence and forms input data for the generative AI model, including control parameters such as maximum output length.

The input of this step is a set of evaluation text records for a product, and the output is a fully formed input data object containing a prompt sentence and concatenated evaluations.

### Step 19:

Server transmits the input data with the prompt sentence to the generative AI model via an application programming interface.

Generative AI model processes the tokenized prompt sentence and evaluation text to generate output text containing a product improvement plan and a price adjustment plan.

Server receives the generated text as a response from the generative AI model and decodes it to obtain a human-readable representation.

The input of this step is the input data containing the prompt sentence and evaluation text, and the output is generated proposal text returned from the generative AI model.

### Step 20:

Server parses the generated proposal text and divides it into structured elements such as individual improvement points and pricing suggestions using pattern recognition or rule-based parsing.

Server stores these structured elements as proposal information for the seller in association with the relevant product and evaluation records in the database.

The input of this step is the generated proposal text from the generative AI model, and the output is a set of structured proposal records stored and indexed in the server's database.

### Step 21:

Server prepares a management interface for the seller that retrieves proposal information along with current listing data and evaluation summaries.

Server assembles a response containing the product attribute information, current price, aggregated evaluation statistics, and AI-generated proposal information and sends it to a terminal operated by the seller.

Terminal renders a dashboard view that highlights recommended product changes and price adjustments.

The input of this step is the stored proposal information and associated listing and evaluation records, and the output is a rendered management interface on the seller's terminal.

### Step 22:

User, acting as a seller, reviews the displayed proposal information on the terminal and decides whether to modify the listing or price according to the suggestions.

User operates the terminal to change fields such as listing description or price and submits the changes.

Terminal sends update requests with the modified values to the server, which validates the updates and applies them to the corresponding database records.

The input of this step is the seller's edit operations on listing and price fields, and the output is updated listing records in the server database that reflect AI-assisted optimization.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented listing systems for network-based commerce primarily automate static form filling and data storage, but they do not substantially improve how the underlying computing resources analyze heterogeneous data, orchestrate complex workflows, or adapt system behavior over time. In typical systems, a server renders fixed templates for sales pages, executes rule-based responses to buyer inquiries, and performs limited batch processing for delivery and review handling. As a result, the processor executes fragmented and rigid procedures that require extensive manual configuration by human operators, and the processor does not effectively leverage machine-generated content or emotion-aware processing to optimize its own operation.

In particular, when generating sales information pages, known systems often require explicit user selection of layout and manual drafting of descriptions. The processor merely injects given text into predefined fields and does not dynamically select layout structures or generate semantically rich content based on machine understanding of merchandise information. This leads to repetitive network traffic for trial-and-error edits, redundant database writes, and inefficient use of processing cycles, because the system cannot automatically converge to an appropriate page structure and content with minimal human input.

Similarly, in buyer-seller communication and delivery handling, conventional systems rely on canned responses or static FAQ matching that are not context-sensitive or emotion-aware. The processor typically applies simple keyword rules without adapting response style or detail level to an estimated user state. This causes additional messaging roundtrips, increased load on the communication subsystem, and higher utilization of compute resources for resolving misunderstandings that could have been prevented by more suitable initial responses. Furthermore, evaluation and review analysis in known systems is often a separate, offline process. Reviews are manually inspected or processed by isolated analytic tools that are not integrated into the core control flow of the commerce platform. The processor does not incorporate the results of natural language analysis or emotion estimation into the generation of prompts for generative models, and does not continuously refine its own prompting strategy. Accordingly, the computing system fails to form a closed feedback loop that improves the quality and efficiency of page generation, communication, delivery guidance, and review-based optimization over time.

In addition, while generative AI models are increasingly available as external services, typical integrations use such models in an ad hoc manner, sending raw text to an external endpoint and directly displaying the returned text to the user. The processor neither structures prompt sentences as first-class control data nor records and analyzes prompt-response pairs as part of its system-level optimization. Without a systematic prompt management mechanism, the computing device cannot stably achieve reproducible behavior, cannot reliably tailor model outputs to different technical sub-tasks, and cannot optimize computation paths for different categories of inputs.

Moreover, conventional systems do not exploit emotion estimation derived from multimodal signals—such as text, audio, and image data—as a parameter for internal workflow control. Even when sentiment analysis is present, it is typically used only for reporting. The processor does not alter the configuration of prompt sentences, template selection, or response generation based on emotion states. Consequently, the system cannot reduce unnecessary follow-up messages, cannot preemptively adjust content complexity or tone, and cannot reduce redundant processing caused by user dissatisfaction or confusion.

Accordingly, there is a need for a computer-implemented system that improves the operation of the server-side computing device by: (i) using prompt sentences as structured control instructions to a generative AI model for selecting templates, generating content, and guiding multiple functional modules; (ii) recording and reusing prompt-response data to dynamically optimize the prompts themselves; and (iii) integrating emotion-aware processing into the orchestration of sales page generation, communication handling, delivery guidance, and review analysis. Such a system should reduce manual configuration, lower the number of processing iterations required to achieve acceptable content, and enhance the overall efficiency and adaptability of the underlying computer system.

The specific processing by the specific processing unit 290 of the data processing device 12 in Application Example 2 is realized by the following means.

The present invention provides a server comprising a processor configured to obtain merchandise information; to analyze the merchandise information by supplying, to a generative AI model, a prompt sentence that instructs the generative AI model to perform analysis of the merchandise information and selection of a display-format template; to select the display-format template according to a result returned from the generative AI model; and to arrange description information and structural elements generated by the generative AI model in the selected display-format template so as to automatically construct a sales information page; to process price-setting input so as to reflect a desired sale price in the sales information page; to generate response information for semi-automatic information exchange with a purchaser by supplying, to the generative AI model, a prompt sentence that instructs generation of a response sentence corresponding to inquiry contents and trade conditions, and to output the response information to a communication interface; to perform semi-automatic delivery processing by obtaining delivery identification information and delivery label information via an external delivery information processing device, generating guidance information related to the delivery label information by supplying, to the generative AI model, a prompt sentence that instructs generation of guidance content, outputting the guidance information, and notifying the purchaser of the delivery identification information; to obtain evaluation information, to analyze descriptive information contained in the evaluation information using natural language processing so as to extract feature information related to characteristics of a merchandise item, and to generate proposal information including a merchandise improvement proposal and a price revision proposal by supplying, to the generative AI model, a prompt sentence that instructs generation of proposals based on the feature information, and to present the proposal information to a seller interface; to obtain conversation information, to estimate an emotion state by applying an emotion estimation model to the conversation information, to dynamically generate a prompt sentence that instructs adjustment of at least one of a response manner and proposal contents according to the emotion state, and to cause the generative AI model to generate emotion-adapted response information or proposal information using the prompt sentence; and to record prompt sentences input to the generative AI model and generated information output from the generative AI model in association with functional contexts, and to update configurations of the prompt sentences based on the recorded data so as to continuously optimize at least a part of sales information page generation processing, information exchange processing, delivery guidance processing, and evaluation analysis processing. This enables the server to use prompt sentences as structured control data for the generative AI model, to form a closed-loop optimization mechanism that refines prompt design based on accumulated prompt-response pairs, and to adjust content generation and workflow behavior according to emotion states, thereby improving the efficiency, adaptability, and technical performance of the underlying computer system in generating sales information pages, conducting buyer-seller communication, handling delivery guidance, and performing review-based merchandise optimization.

The term “merchandise information” refers to information representing attributes of an item to be offered for sale, including at least one of an identifier, a category, a name, a description, a price, an image reference, and other descriptive data used to construct a sales information page.

The term “sales information page” refers to an electronic document or screen generated by a computing device for presentation on a user interface, the electronic document or screen including at least a description of merchandise information, a price, and information for enabling a transaction related to the merchandise.

The term “display-format template” refers to layout data defining a structural arrangement of user interface elements on a sales information page, including positions, grouping, and visual hierarchy for text, images, and interactive components, without being limited to specific content values.

The term “display-format identifier” refers to symbolic information, such as a label or code, indicating a type of display-format template to be used when constructing a sales information page.

The term “generative AI model” refers to a machine-learned model configured to generate output data, including natural language text, based on input data and a prompt sentence, the machine-learned model including at least one neural network trained on sample data.

The term “prompt sentence” refers to machine-readable instruction data supplied to a generative AI model, the instruction data including at least one of a natural language expression, a structured format, or parameter information that specifies a task, constraints, or a desired output style for the generative AI model.

The term “description information” refers to textual content that describes characteristics, functions, usage, or benefits of merchandise, the textual content being generated or refined by a generative AI model or other text generation mechanism.

The term “structural elements” refers to components of a user interface layout, including headings, paragraphs, bullet lists, image containers, action buttons, and other interface elements that are placed into positions defined by a display-format template.

The term “desired sale price” refers to price information input or confirmed by a seller, the price information indicating an intended monetary amount at which the seller wishes to offer the merchandise.

The term “information exchange” refers to communication processing between a seller-side system and a purchaser-side system, including at least transmission and reception of inquiries, responses, notifications, and status updates related to merchandise or transactions.

The term “communication screen” refers to a user interface region that displays exchanged messages between parties, such as inquiries and responses, and that allows input of further messages for interactive communication.

The term “delivery information” refers to information associated with shipment of merchandise, including at least a destination, a source, a carrier, a package characteristic, and scheduling data used for arranging transportation.

The term “delivery information processing device” refers to an information processing system, such as a carrier system or a logistics system, configured to generate or provide delivery identification information and delivery label information based on delivery information.

The term “delivery identification information” refers to data used for identifying a shipment, including at least one of a tracking number, a shipment identifier, or similar routing information used by a delivery information processing device.

The term “delivery label information” refers to data used for generating a shipping label, including at least a sender address, a recipient address, carrier codes, and other machine-readable and human-readable information printed or displayed on a label attached to a package.

The term “guidance information” refers to text or other content generated for explaining delivery-related operations, including at least instructions for printing, attaching, or using a delivery label, and instructions for handing over a package to a carrier.

The term “evaluation information” refers to feedback data related to merchandise or transactions, including at least a rating value, a review text, and metadata such as a timestamp or a buyer identifier.

The term “descriptive information” refers to natural language content contained in evaluation information, including at least free-form text written by a user that expresses opinions, experiences, or comments about merchandise or services.

The term “natural language processing” refers to computational processing of human language text, including at least tokenization, parsing, part-of-speech tagging, entity extraction, sentiment analysis, topic extraction, or other operations that interpret or transform text.

The term “feature information” refers to data derived from descriptive information through natural language processing, the data representing characteristics, issues, strengths, or usage contexts of merchandise, which can be used for further analysis or proposal generation.

The term “proposal information” refers to generated data representing at least one suggested modification, improvement, or adjustment, including at least a merchandise improvement proposal or a price revision proposal.

The term “merchandise improvement proposal” refers to proposal information indicating recommended changes to at least one aspect of merchandise, such as features, documentation, usability, or presentation, derived from analysis of evaluation information or other data.

The term “price revision proposal” refers to proposal information indicating a suggested change to a sale price of merchandise, including at least an increase, decrease, or maintenance of the current price, and a reason for the suggested change.

The term “seller screen” refers to a user interface provided to a seller, the user interface being configured to display sales information pages, proposal information, and operational controls for managing merchandise listings and communications.

The term “conversation information” refers to information representing exchanges of messages or utterances between a system and a user, including textual messages, transcribed speech, timestamps, and associated metadata.

The term “emotion estimation model” refers to a machine-learned model configured to estimate an emotion state based on input data, such as text, audio, or images, the model outputting at least one label or score representing an emotional category or intensity.

The term “emotion state” refers to data representing an estimated emotional condition of a user, such as satisfaction, frustration, anger, confusion, or joy, as determined by an emotion estimation model.

The term “response manner” refers to characteristics of generated communication, including at least a writing style, tone, politeness level, detail level, and presence or absence of specific expressions such as apologies.

The term “generated information” refers to output data produced by a generative AI model in response to a prompt sentence, including at least text, structured content, identifiers, or other machine-usable or human-usable data.

The term “functional context” refers to information indicating a functional role or processing stage associated with a prompt sentence and generated information, such as page generation, communication handling, delivery guidance, or evaluation analysis.

The term “sales information page generation processing” refers to processing that constructs or updates a sales information page, including at least analysis of merchandise information, selection of a display-format template, and placement of content within the template.

The term “information exchange processing” refers to processing that manages communication between a seller and a purchaser, including at least receiving inquiries, generating responses using a generative AI model, and controlling display of such communications.

The term “delivery guidance processing” refers to processing that manages generation and presentation of guidance information related to delivery, including at least use of delivery identification information and delivery label information.

The term “evaluation analysis processing” refers to processing that analyzes evaluation information, including natural language analysis of descriptive information, extraction of feature information, and generation of proposal information.

The term “user interface” refers to a hardware and software combination that enables a human user to interact with a computing device, including at least display components, input components, and associated control logic.

The term “semi-automatic” refers to processing in which a computing device performs a portion of operations automatically based on data and models, while at least one operation is performed or confirmed by a human user.

Server, terminal, and user cooperate to implement various embodiments of the invention as described below. Each embodiment may be implemented independently or in combination, and each embodiment supports the scope of the claims.

### Server:

Server includes at least one processor, a memory, a non-transitory storage medium, a communication interface, and optionally a graphics processing unit. Server may be implemented on one or more physical machines, such as a rack-mounted computing device in a data center or a virtual computing instance in a cloud environment. Server executes an operating system, such as a general-purpose operating system, and an application stack including, for example, a web framework, an HTTP server, and database drivers.

### Server:

Server executes an application including a backend framework, such as a framework that provides routing, request handling, and object-relational mapping; an application server; and a database system such as a relational database. Server may additionally use a message queue system and a background job engine for asynchronous processing. Server stores merchandise information, prompt sentences, generated information, emotion analysis results, and proposal information in data structures such as relational tables or key-value stores.

### Terminal:

Terminal includes a processor, a display, an input device such as a touchscreen or keyboard, a network interface, and optionally a camera and microphone. Terminal executes a client application, such as a web browser, a native mobile application, or a desktop application. Terminal communicates with server using a network protocol and displays user interfaces defined by server-side or client-side components.

### User:

User operates terminal to provide merchandise information, to review automatically generated sales information pages, to adjust prices, and to respond to suggestions. User may be a seller, a buyer, or another operator depending on system configuration.

### Server:

Server provides multiple logical modules including a merchandise information module, a template management module, a prompt management module, a generative AI interaction module, a communication module, a delivery module, an evaluation analysis module, and an emotion module. These modules exchange data via defined interfaces and shared data structures. For example, the merchandise information module stores and retrieves normalized merchandise records, each record including an identifier, a category identifier, attribute vectors, and metadata.

### Server:

Server implements data structures that support technical effects. For merchandise information, server stores each item as a record including: a primary key; external identifiers; a category code; a vector of normalized attributes; a reference to raw textual descriptions; and a reference to image resources. For prompt sentences, server stores each prompt as a record including: a functional context identifier (e.g., “layout_selection”, “description_generation”, “review_proposal”); a base text template; parameter placeholders; and performance metrics such as response length, user acceptance rate, and latency. By storing prompt sentences with functional context and performance metrics, server can adapt prompts to improve computational efficiency and quality over time.

### Server:

Server includes a generative AI interaction module that communicates with an external or internal generative AI model. The generative AI model may be implemented as a neural network with a sequence-to-sequence architecture, such as a transformer-based model with multiple encoder and decoder layers. The model typically includes multi-head attention layers, feedforward layers, layer normalization, and positional encodings. The model is trained on text data using a training objective such as next-token prediction or masked token prediction. During inference, the model receives as input a tokenized representation of a prompt sentence and produces output tokens representing generated information.

### Server:

Server represents input prompt sentences and generated information as sequences of tokens stored in memory. Server uses an encoding function to convert characters into token identifiers and stores attention masks for each sequence. Server sends token sequences to the generative AI model via a communication interface or local function call and receives output token sequences, which are then decoded into natural language text. In some embodiments, server constrains output using decoding parameters such as maximum length, temperature, top-k selection, and top-p selection to balance diversity and determinism.

### Server:

Server employs a specific prompt management strategy that improves technical performance. Server does not send arbitrary natural language text to the generative AI model; instead, server constructs structured prompt sentences that include explicit markers for functional context, input data format, and expected output format. For example, for template selection, server may construct a prompt sentence of the form:
“You are a layout selector. Based on the following merchandise category and attributes, choose the best layout ID among: [layout_simple, layout_premium, layout_compact]. Output only the layout ID. Category: ‘Book’. Attributes: audience=‘beginner’, price_range=‘low’, has_many_images=false.”

By constraining the model to output only a layout identifier, server simplifies downstream parsing and reduces the probability of invalid outputs, thereby decreasing error-handling costs and improving throughput.

### Server:

Server stores prompt-response pairs and their associated performance metrics in a log table. Each log record includes: a hash of the prompt sentence; an identifier of the generative AI model version; the functional context; timing information; a length of the response; and a quality indicator such as a user acceptance flag or an automatic validation score. Server can periodically analyze these records using a separate optimization process to adjust prompt formulations, for example by adding or removing constraints or reordering instructions. This closed-loop optimization of prompt sentences reduces the number of failed generations and re-generations, thereby decreasing computational load on the generative AI model and improving response time.

### Server:

Server incorporates an emotion estimation model that provides emotion states for text, audio, or image-based signals. For text, server converts review text or conversation text into embeddings using a neural encoder, such as a transformer encoder. These embeddings are fed into classification layers that output probabilities for discrete emotion classes such as satisfaction, frustration, anger, confusion, and joy. The classification network is trained using supervised learning with labeled examples. The training objective may be cross-entropy loss, and weights are updated by gradient descent or a variant such as Adam. Server may use data augmentation techniques such as paraphrasing or synonym replacement to increase robustness. For audio, server may convert a signal into a spectrogram and feed the spectrogram into a convolutional or recurrent network that produces emotion probabilities. For images, server may apply a convolutional neural network trained for facial expression recognition.

### Server:

Server integrates emotion states into prompt sentences as explicit parameter values. For instance, when generating a response to a buyer message, server may create a prompt sentence containing an emotion component:
“The buyer emotion is ‘frustrated’. Answer with a calm, apologetic, and detailed tone. Buyer message: ‘The delivery was very late and I am disappointed.’ Store policy: ‘Shipments are normally dispatched within two business days.’ Provide a response that acknowledges the delay and proposes a remedy.”

By incorporating emotion states into prompt sentences, server guides the generative AI model to produce communication that is more likely to resolve issues in fewer messages. This reduces the number of network roundtrips and the number of model inference calls required to close a conversation, thereby lowering communication and computational load.

### Server:

Server processes evaluation information using a combination of rule-based and learned algorithms. Server stores each review in a review table with fields for rating, text, user identifier, product identifier, and timestamp. An analysis pipeline retrieves recent reviews and applies natural language processing steps such as tokenization, stop-word removal, lemmatization, and topic extraction. Topic extraction may be implemented using a topic model or a neural-based clustering method applied to embeddings. The pipeline produces feature information summarizing common themes, such as usability problems, documentation clarity, or perceived value.

### Server:

Server supplies this feature information to a generative AI model using prompt sentences that explicitly request structured proposals. For example, server may construct a prompt sentence of the form:
“You are a product manager assistant. Based on the following analysis of user reviews, propose up to three concrete improvement actions and specify whether the price should be kept, increased, or decreased. Provide brief reasons for each action. Review analysis: overall_sentiment=‘mixed’; issues: usability(12), manual_clarity(7). Current price: 1500 JPY.” Server then parses the generated proposals and stores them as structured proposal information that can be presented on a seller screen. Server may optionally validate generated content by checking for keyword presence or by comparing suggested price changes to configured bounds. This combination of automated topic extraction and guided generative proposals reduces manual analytic work and improves the quality of the proposals, while also providing a repeatable, machine-verifiable workflow.

### Server:

Server manages delivery information by integrating with external delivery information processing devices. Server stores delivery requests in a delivery table containing shipment identifiers, sender and recipient addresses, package characteristics, and carrier codes. When generating a shipping label, server communicates with a carrier system via an API, receives delivery identification information and delivery label information, and stores them as structured binary or text data. Server can then generate guidance information using a prompt sentence such as:
“Create concise, step-by-step instructions for the seller on how to print and attach the following shipping label and how to hand over the package to the carrier. Shipping label data: [summary of label fields].”

This results in textual guidance that is tailored to the specific label format and carrier requirements. The guidance reduces human error in physical handling, such as misplacement of labels or incorrect drop-off procedures, which in turn reduces failed deliveries and associated system overhead for exception processing.

### Terminal:

Terminal provides graphical user interfaces that interact with server's modules. For merchandise registration, terminal displays fields for identifiers and basic attributes, and sends input in a defined structured format. For template selection and page preview, terminal receives layout identifiers and content blocks from server and assembles them into visual pages. For communication, terminal presents a conversation interface and transmits user-entered messages to server; terminal also displays responses and emotion indications if appropriate. For delivery, terminal displays links to generated labels and renders guidance information for printing and physical handling.

### User:

User benefits from server's technical improvements by needing fewer manual editing steps and receiving higher quality content and guidance. User does not have to understand the internal prompt management or neural architectures, but user receives improved responsiveness, fewer communication failures, and more relevant suggestions.

### Server:

Server applies specific optimization measures to support technical improvements beyond mere automation of human tasks. First, by using specialized prompt sentences that constrain output formats and content, server minimizes parsing complexity and reduces malformed outputs. Second, server stores contextual prompt-response pairs and automatically adjusts prompts based on observed model behavior, which constitutes a feedback-based configuration adaptation that reduces average latency and error rates. Third, server uses emotion estimation not just for presentation but as a control parameter for internal workflows: an estimated emotion state may alter which module is invoked, what information is fetched from databases, and which decoding parameters are used for the generative AI model. These mechanisms change the way the computing device allocates resources, sequences operations, and formats data, thereby improving computational efficiency and robustness.

### Server:

Server can implement multiple variations of the generative AI interaction. In some embodiments, server uses a large general-purpose generative model hosted externally; in other embodiments, server uses a smaller, domain-specific model hosted locally. In a local-hosted embodiment, server loads model parameters into memory and executes attention and feedforward operations on a graphics processing unit, using batched inference to serve multiple prompt sentences in parallel. Server may maintain separate queues for different functional contexts (e.g., page generation versus communication) and schedule inference jobs according to priority, which reduces latency for time-critical functions such as buyer communication while allowing background tasks such as batch review analysis to be processed with lower priority.

### Server:

Server uses non-trivial data structures to represent prompts and related metadata. For each functional context, server may maintain a prompt template library, where each entry includes: a base string; parameter slots; a target output schema; and an associated scoring function. The scoring function may be defined over log records and may include terms such as average user acceptance, rate of model constraint violations, and average token count. An optimization algorithm may periodically re-rank template entries based on these scores and select the best-performing templates for future use. This internal optimization is not equivalent to simply replacing human writing with machine writing; instead, it changes how the system controls the generative model and optimizes its behavior as a component of the overall computing architecture.

### Server:

Server enables multiple alternative embodiments. In one embodiment, server restricts use of the generative AI model to layout selection and descriptive text generation, while responses to buyer inquiries remain rule-based. In another embodiment, server uses the generative AI model in all major modules, including layout selection, description generation, response generation, guidance generation, and proposal generation. In a further embodiment, server uses separate generative AI models for different contexts, such as one model tuned for short transactional messages and another model tuned for long-form descriptions. Each model can have its own prompt libraries and optimization cycles. These variations allow the system to be adapted to different performance, cost, and regulatory requirements.

### Server:

Server may employ additional algorithms for validating and post-processing generated outputs to ensure technical reliability. For instance, when the generative AI model outputs a layout identifier, server validates the identifier against a known list to prevent invalid template references. When the generative AI model outputs a price-related recommendation, server checks that suggested prices fall within configured limits and that they do not violate business rules. For textual responses, server may apply lexical filters to remove prohibited content and to enforce length limits. These validation procedures reduce the likelihood of inconsistent states in the database and protect the system from erroneous AI outputs.

### Server:

Server can reduce communication load and improve data management through advanced caching and content reuse. When generating similar descriptions for multiple variants of a merchandise item, server may reuse previously generated components and only call the generative AI model for delta parts, such as differences in size or color. Server can cache template selections for products in the same category with similar attributes, avoiding redundant calls to the generative AI model. This approach significantly reduces the number of tokens processed by the model and the amount of data transmitted over the network, which in turn reduces energy consumption and improves system scalability.

### Terminal:

Terminal may also participate in technical optimization by pre-processing some data locally. For example, terminal may perform barcode recognition, speech-to-text conversion, or basic sentiment indicators before sending data to server. This local pre-processing can reduce the amount of raw data that needs to be transmitted and can allow server to concentrate on higher-level analytic and generative tasks. However, critical AI decisions and prompt management remain on server, ensuring centralized control and consistent behavior.

### User:

User can optionally override or refine AI-generated content via terminal interfaces. When user edits generated text or modifies automatically selected templates, server can capture these edits as feedback signals associated with the original prompt-response pair. Server can incorporate this feedback into its optimization process by marking certain outputs as low quality or by adjusting performance metrics for corresponding prompt templates. Over time, this feedback loop further refines prompt sentences and improves the internal heuristics used for template selection and content generation.

### Server:

Server supports fail-safe modes and alternative procedures. If the generative AI model is unavailable or a prompt-response cycle fails, server can fall back to default templates and static description placeholders. Server can also switch to simple rule-based responses for communication when needed. This ensures that the system remains operational even when advanced AI components experience downtime, thereby improving reliability of the overall computing infrastructure.

Through these embodiments, server, terminal, and user interact in a manner that not only automates certain tasks but also improves computer technology itself. The described architectures, data structures, prompt management strategies, and emotion-aware control mechanisms enable the system to reduce processing iterations, lower network and compute load, improve accuracy of content and emotion alignment, and enhance robustness and scalability of the underlying computing environment.

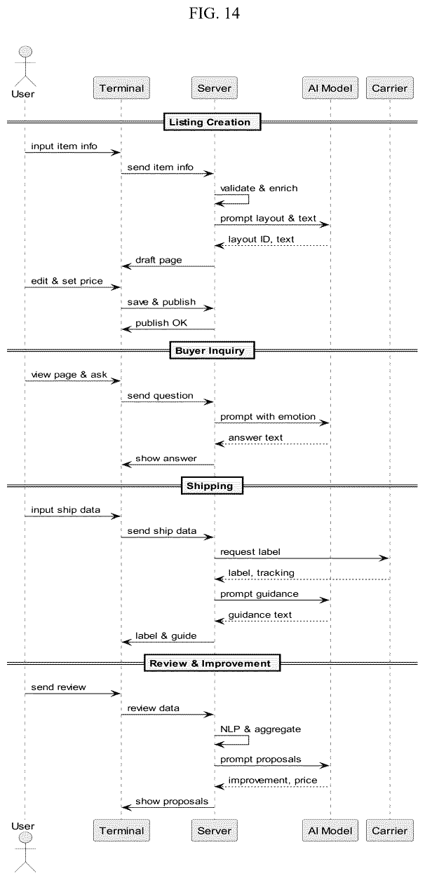

The following describes the processing flow using FIG. 14.

### Step 1:

Terminal displays a merchandise registration screen to the user.

Terminal receives input including at least one merchandise identifier (such as a code or name) and optional basic attributes (such as category and brief description). Terminal packages this input as a structured data object and sends it to server via a network request.

Input: raw user input (identifier text, category selection, brief text), device and session metadata.

Output: a structured request message sent to server.

Terminal converts keystrokes and UI selections into a JSON-like structure, attaches a session token and timestamp, and transmits the structure over a secure channel.

### Step 2:

Server receives the merchandise registration request from terminal.

Server validates the input format (length, allowed characters, required fields) and writes a preliminary merchandise record into a database with status set to “pending_analysis.”

Input: structured merchandise registration request from terminal.

Output: normalized merchandise record stored in a merchandise table and an acknowledgment response to terminal.

Server parses the request, maps fields to internal columns, assigns a unique internal identifier, and persists the record using a data access layer.

### Step 3:

Server obtains detailed merchandise information from internal or external sources.

Server uses the merchandise identifier as a key to query one or more product information services or internal catalogs and merges returned attributes (such as full title, author, release date, and raw description) into the merchandise record.

Input: internal merchandise identifier and original identifier data.

Output: enriched merchandise data structure with additional attributes, stored back into the database.

Server sends HTTP requests to external services, parses responses, resolves conflicts among sources, and updates the record with normalized fields and references to media resources.

### Step 4:

Server derives category and attribute vectors for template selection.

Server processes textual fields to extract category codes and attribute values (such as audience type or complexity level), converts them into a structured vector, and associates the vector with the merchandise record.

Input: enriched merchandise data (text fields, numeric fields, metadata).

Output: category information and attribute vector stored as part of the merchandise record.

Server tokenizes text, applies simple classification or lookup rules, encodes results as a dense vector, and writes the vector to a dedicated attribute column.

### Step 5:

Server constructs a prompt sentence for layout/template selection by a generative AI model.

Server uses a prompt template for layout selection, fills parameter slots with the category information and attribute vector, and builds a complete prompt sentence that instructs the generative AI model to output only a layout identifier.

Input: category information and attribute vector.

Output: a text prompt sentence ready for submission to the generative AI model.

Server concatenates template strings, inserts category labels and attribute values, and stores the resulting prompt together with a functional context tag.

### Step 6:

Server submits the layout-selection prompt sentence to the generative AI model and receives a layout identifier.

Server tokenizes the prompt, sends it to the generative AI model (locally or remotely), and decodes the model's output into a layout identifier string.

Input: layout-selection prompt sentence.

Output: layout identifier indicating a specific display-format template.

Server converts text to token IDs, invokes model inference, receives output tokens, converts them back to text, verifies that the result matches an allowed set of template IDs, and logs the prompt-response pair.

### Step 7:

Server selects the display-format template and prepares a draft structure of the sales information page.

Server maps the layout identifier to a concrete template configuration, which defines regions for titles, descriptions, bullet lists, images, and price, and initializes an in-memory representation of the page with empty content slots.

Input: layout identifier and merchandise record identifier.

Output: a page layout structure associated with the merchandise record.

Server looks up the template in a template table, loads layout specifications, and creates a data object that binds the template to the specific merchandise record.

### Step 8:

Server generates a prompt sentence for descriptive content creation by the generative AI model.

Server gathers merchandise attributes (title, extracted features, target audience) and constructs a prompt sentence instructing the generative AI model to generate a descriptive text and feature bullet points in a defined style and length.

Input: enriched merchandise data and selected template type.

Output: a descriptive-content prompt sentence.

Server merges static instructions (“You are a copywriter . . . ”) with dynamic merchandise data, explicitly specifying output sections (description, bullets) and desired constraints such as length and tone.

### Step 9:

Server sends the descriptive-content prompt sentence to the generative AI model and receives generated description information and structural text elements.

Server transmits the prompt to the model, decodes the output into separate segments (e.g., main description and bullet list), and stores them as content blocks linked to the merchandise record.

Input: descriptive-content prompt sentence.

Output: generated description text and feature bullet texts.

Server uses delimiter markers or parsing rules specified in the prompt to split the returned text into sections and saves each section in structured fields.

### Step 10:

Server inserts the generated description information and structural elements into the selected display-format template.

Server binds the generated content blocks to layout slots (e.g., main description area, bullet list area) and renders a draft sales information page structure, which may be stored as HTML, a template-specific data tree, or both.

Input: layout structure and generated content blocks.

Output: a complete draft sales information page associated with the merchandise record.

Server applies template rules to order and format content, generates markup or structured layout data, and stores the rendered result for retrieval by terminal.

### Step 11:

Terminal requests the draft sales information page and displays it to the user for confirmation.

Terminal receives the rendered layout and content, interprets the page structure, and displays the title, description, bullet points, and image placeholders to the user.

Input: page layout and content data from server.

Output: a visual representation of the sales information page on terminal's display.

Terminal translates the received structure into UI components, allocates screen space, and renders text and images in the defined positions.

### Step 12:

User reviews the draft page and enters a desired sale price and optional edits.

User inspects the automatically generated content, modifies text if needed using input controls, and sets a desired sale price using a numeric input field.

Input: displayed page content and price input field.

Output: user-edited content and desired sale price transmitted to terminal's local state.

User interacts with the UI by typing and selecting elements; terminal updates local data structures accordingly.

### Step 13:

Terminal sends the final content and desired sale price to server for publication.

Terminal packages the edited description, bullet points, and the desired sale price into a structured message and transmits it to server through a secure endpoint for saving and publishing.

Input: user-edited content and desired sale price.

Output: a publication request message sent to server.

Terminal validates that the price is numeric, serializes the data, and attaches a merchandise identifier and authentication token.

### Step 14:

Server validates the price and user edits, then finalizes and publishes the sales information page.

Server checks the desired sale price against predefined rules (such as minimum and maximum allowed values) and validates edited content for length and prohibited terms. Server then updates the merchandise record and marks the page status as “published.”

Input: publication request message including content and price.

Output: updated merchandise record and a published sales information page accessible via a public identifier.

Server runs validation routines, updates database fields, triggers cache invalidation or search index updates if necessary, and generates a public URL for the page.

### Step 15:

Terminal displays the confirmation of publication to the user.

Terminal receives server's confirmation data, including the public page link, and displays a message indicating successful publication and a link to view the live page.

Input: publication confirmation from server.

Output: confirmation screen with link on terminal.

Terminal updates its navigation state and may store the URL for future access.

### Step 16:

Buyer's terminal displays the published sales information page and allows communication initiation.

Terminal of a buyer retrieves the public page from server, renders the layout, and shows an interface element (such as a “Contact seller” button or chat entry field) for inquiries.

Input: page data from server and user interaction events.

Output: rendered product page and potential inquiry messages prepared for transmission.

Terminal loads page data, builds visual components, and listens for user actions that initiate messaging.

### Step 17:

Buyer uses the terminal to send an inquiry message about the merchandise.

Buyer enters a question in the communication interface, such as a text input, and triggers sending; terminal forwards this text to server as a message object.

Input: buyer's typed question in the UI.

Output: structured inquiry message sent to server.

Terminal encapsulates the text, adds conversation identifiers, and sends the message through a messaging endpoint.

### Step 18:

Server receives the inquiry and optionally applies a preliminary classification to determine intent and urgency.

Server stores the message, analyzes text for keywords or simple patterns, and tags the message with an intent label (such as “shipping_time” or “price_question”) and a priority level.

Input: structured inquiry message.

Output: enriched message record with intent and priority tags.

Server uses a lightweight classifier or rule-based component to categorize the message and writes the result to a message table.

### Step 19:

Server estimates the buyer's emotion state from the inquiry text.

Server processes the inquiry text with an emotion estimation model to compute emotion probabilities and selects an emotion state label, such as “neutral” or “frustrated,” which is associated with the conversation.

Input: inquiry text and optional conversation history.

Output: emotion state label and probability vector.

Server tokenizes the text, produces embeddings, feeds them to the classifier, calculates softmax probabilities for each emotion class, and stores the top label and confidence scores.

### Step 20:

Server constructs a prompt sentence for response generation that incorporates inquiry content, policy data, and emotion state.

Server retrieves relevant merchandise and policy data, then builds a prompt sentence that instructs the generative AI model how to answer, specifying tone, detail level, and constraints based on the emotion state.

Input: inquiry text, emotion state, merchandise data, and policy data.

Output: response-generation prompt sentence.

Server merges these elements into a structured instruction, such as: “The buyer emotion is ‘angry’. Answer with a calm, apologetic tone . . . Buyer message: . . . Policy: . . . ”

### Step 21:

Server sends the response-generation prompt sentence to the generative AI model and obtains a draft response.

Server tokenizes the prompt, executes model inference, decodes the output, and stores the generated response text along with the prompt and context information.

Input: response-generation prompt sentence.

Output: generated response text and associated metadata.

Server processes the model output, trims it to acceptable length, checks for prohibited content, and records both prompt and output in a logging structure.

### Step 22:

Server optionally validates and adjusts the generated response according to technical constraints. Server enforces system policies by checking that generated text remains within content and format restrictions (e.g., no personal data, no unsupported promises) and, if necessary, truncates or replaces certain parts with standard phrases.

Input: raw generated response text and policy constraints.

Output: sanitized response text ready to be delivered to terminal.

Server runs text checks, applies replacement rules, and stores the final version of the response.

### Step 23:

Server sends the final response text to the buyer's terminal for display in the communication interface.

Server wraps the sanitized response in a message object and pushes it via a communication channel associated with the conversation.

Input: sanitized response text and conversation identifier.

Output: outgoing message delivered to buyer's terminal.

Server queues the message, persists its status, and signals the communication subsystem to forward it to the appropriate terminal.

### Step 24:

Buyer's terminal displays the system-generated response in the conversation view.

Terminal receives the message, appends it to the message list, and notifies the buyer visually or audibly that a response has arrived.

Input: response message object from server.

Output: updated chat interface containing the system response.

Terminal inserts the new message into the UI component tree, scrolls as needed, and triggers notification mechanisms.

### Step 25:

Seller's terminal optionally displays the conversation and allows manual intervention.

Seller's terminal retrieves conversation logs from server and presents messages and system-generated responses; user can override or supplement a response by sending an additional message.

Input: conversation data from server.

Output: seller's view of dialogue and optional outgoing seller messages.

Terminal renders the conversation, provides input fields, and submits seller-entered messages back to server.

### Step 26:

Seller's terminal receives an order notification and prompts the seller to initiate delivery processing.

Terminal displays order details and an action for generating delivery information, such as entering package size and confirming address.

Input: order confirmation data from server.

Output: user prompt to enter delivery-related data.

Terminal populates a delivery form with known information and awaits user input.

### Step 27:

User enters delivery parameters through the terminal.

User confirms or modifies delivery address, specifies package dimensions and weight, and selects a carrier when allowed; terminal collects these values.

Input: user input of delivery parameters.

Output: structured delivery request to be sent to server.

Terminal checks field completeness and formats the data for transmission.

### Step 28:

Terminal sends the delivery request to server for integration with a delivery information processing device.

Terminal transmits the package characteristics and addresses over a secure channel to server's delivery endpoint.

Input: structured delivery parameter set.

Output: delivery request message at server.

Terminal ensures secure transport and associates the request with a specific order ID.

### Step 29:

Server creates a shipment record and requests delivery identification information and label data from a carrier system.

Server stores the delivery request, calls the external carrier API, and receives tracking and label data, which is stored and linked to the order.

Input: delivery parameters and authentication credentials.

Output: shipment record containing delivery identification information and label data.

Server builds an API request, sends it to the carrier system, parses the response, converts label information into a storable form, and updates the shipment entry.

### Step 30:

Server constructs a prompt sentence for generating guidance information related to the shipping label and handling steps.

Server summarizes label data and carrier instructions into a prompt that asks the generative AI model to produce simple, step-by-step instructions for the seller.

Input: shipment record and carrier-related data.

Output: guidance-generation prompt sentence.

Server injects label fields and carrier requirements into an instruction template describing the desired explanation.

### Step 31:

Server sends the guidance-generation prompt sentence to the generative AI model and receives textual guidance information.

Server performs model inference, decodes output, and saves the resulting guidance text associated with the shipment.

Input: guidance-generation prompt sentence.

Output: guidance text explaining printing and attachment procedures.

Server persists the guidance text in the shipment record and logs prompt-response relations.

### Step 32:

Server sends shipping label data and guidance text to seller's terminal.

Server prepares a compound response including a link or payload for the label and the generated instructions, then transmits it to the seller's device.

Input: stored label data and guidance text.

Output: delivery guidance package sent to terminal.

Server ensures correct encoding of file data and associates the package with the appropriate user session.

### Step 33:

Seller's terminal displays guidance and provides access to the shipping label.

Terminal shows instructions to the seller, displays a preview of the shipping label, and offers options to download or print.

Input: delivery guidance package.

Output: user interface elements for viewing and managing the label.

Terminal renders both text instructions and label preview, integrates print functions, and stores state to track whether the label has been printed.

### Step 34:

Buyer's terminal later receives delivery status updates based on delivery identification information.

Server periodically checks delivery status via carrier interfaces and sends updates (e.g., “shipped,” “out for delivery”) to the buyer's terminal, which displays them in the order tracking view.

Input: delivery identification information and carrier status.

Output: order status messages rendered on buyer's terminal.

Server polls or subscribes to status events, converts them into notifications, and terminal updates display accordingly.

### Step 35:

Buyer's terminal prompts the buyer to submit evaluation information after delivery.

Terminal detects delivery completion and presents a review interface, allowing entry of a rating and text comment.

Input: completion signal and user actions.

Output: review data prepared for submission.

Terminal captures user input and formats it into a structured review record.

### Step 36:

Terminal sends evaluation information to server.

Terminal sends rating values and descriptive text to server's review endpoint.

Input: structured review content.

Output: review submission request at server.

Terminal attaches order and product identifiers and transmits the packet securely.

### Step 37:

Server stores the review and triggers processing by the evaluation analysis module.

Server inserts the review into a review table and marks it for analysis, possibly enqueuing it in a background job queue.

Input: submitted review record.

Output: persisted review and queued analysis task.

Server writes review data and updates a queue or flag for subsequent batch processing.

### Step 38:

Server performs natural language processing on descriptive information to extract feature information.

Server tokenizes and preprocesses the review text, runs sentiment or topic extraction, and generates a feature vector describing issues and sentiments for the merchandise.

Input: review text and associated metadata.

Output: feature information and sentiment summary.

Server applies NLP pipelines, computes sentiment scores, identifies key terms or topics, and stores results linked to the review and merchandise.

### Step 39:

Server aggregates feature information across multiple reviews and estimates overall sentiment and major issues.

Server groups feature vectors for a merchandise item, calculates frequencies or weights for specific topics, and derives an overall sentiment classification.

Input: feature information for multiple reviews of the same merchandise.

Output: aggregated review analysis structure.

Server executes aggregation queries, calculates statistics, and writes aggregate results into an analytics table.

### Step 40:

Server builds a prompt sentence for generating merchandise improvement and price revision proposals using the generative AI model.

Server incorporates aggregated feature information, current price, and sales performance parameters into a prompt that instructs the generative AI model to suggest improvements and price changes with reasons.

Input: aggregated review analysis, current price, and optional metrics.

Output: proposal-generation prompt sentence.

Server assembles a detailed instruction string that describes inputs and requests output in a structured, interpretable format.

### Step 41:

Server sends the proposal-generation prompt sentence to the generative AI model and receives proposal information.

Server runs model inference, decodes the output into one or more concrete proposals, and parses them into structured data fields.

Input: proposal-generation prompt sentence.

Output: merchandise improvement and price revision proposals stored in the database.

Server extracts suggested actions, price decisions, and reasoning from the text and maps them into internal proposal records.

### Step 42:

Server presents proposal information to the seller via the seller's terminal.

Server sends proposal records to the terminal, which displays them as suggestions that can be accepted, modified, or dismissed.

Input: structured proposal information.

Output: visual suggestion elements on the seller's interface.

Terminal renders suggestions with actions such as “Apply this change” or “Ignore,” while server awaits feedback actions.

### Step 43:

User reviews proposals and optionally applies them, sending feedback back to server.

User reads the suggested changes and may accept or reject them; terminal sends the outcome to server for recording and application.

Input: user decisions on each proposal.

Output: feedback messages to server and possibly updated merchandise configuration.

Terminal captures button presses or selections, formats them into commands, and transmits those commands to server.

### Step 44:

Server applies accepted proposals and updates prompt and model-control strategies based on feedback and performance metrics.

Server adjusts merchandise attributes or price based on accepted proposals, updates prompt performance logs to reflect acceptance or rejection, and may modify or re-rank prompt templates for future use.

Input: feedback on proposals and associated prompt-response records.

Output: updated merchandise data and refined prompt template configurations.

Server executes database updates, recalculates prompt scores, and stores new configuration parameters that will influence subsequent prompt construction and processing flows.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

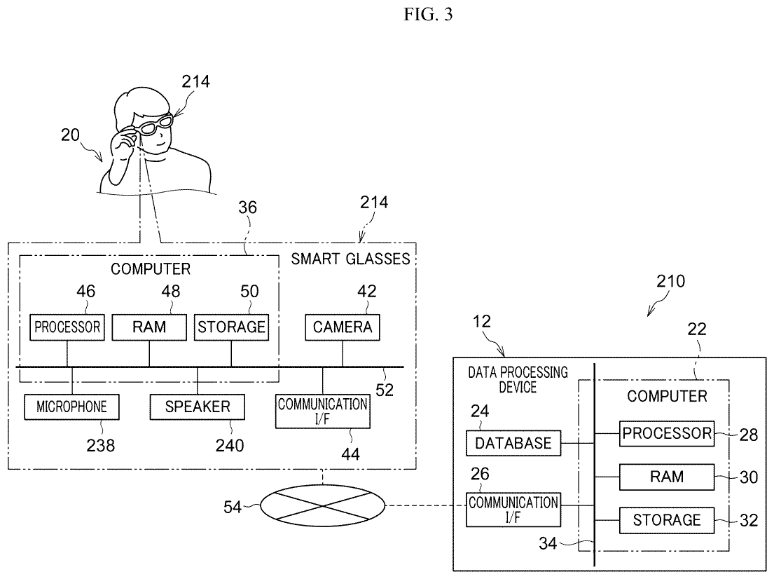

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

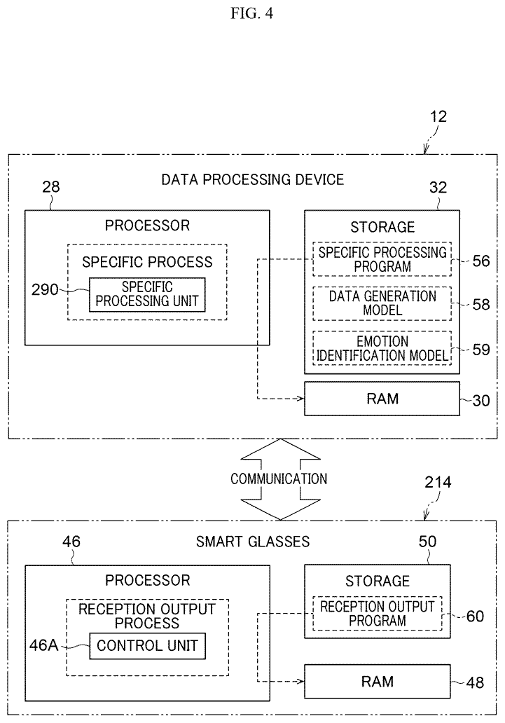

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

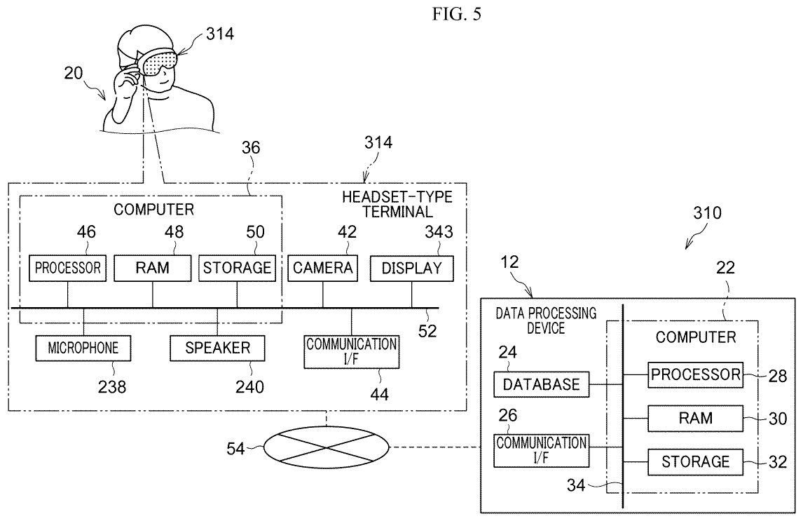

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

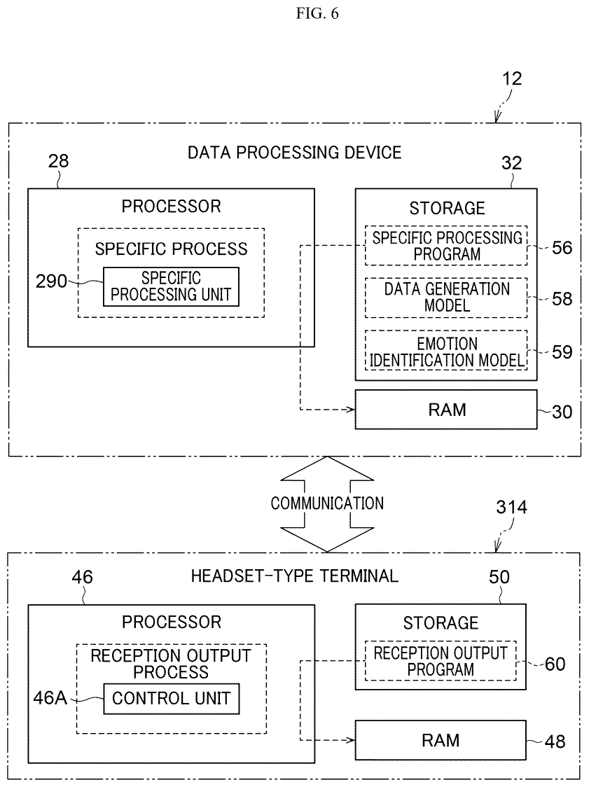

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

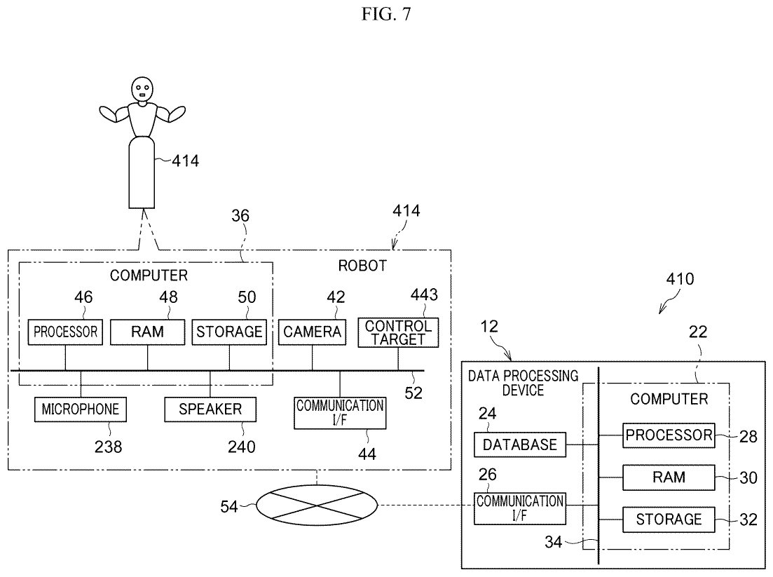

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

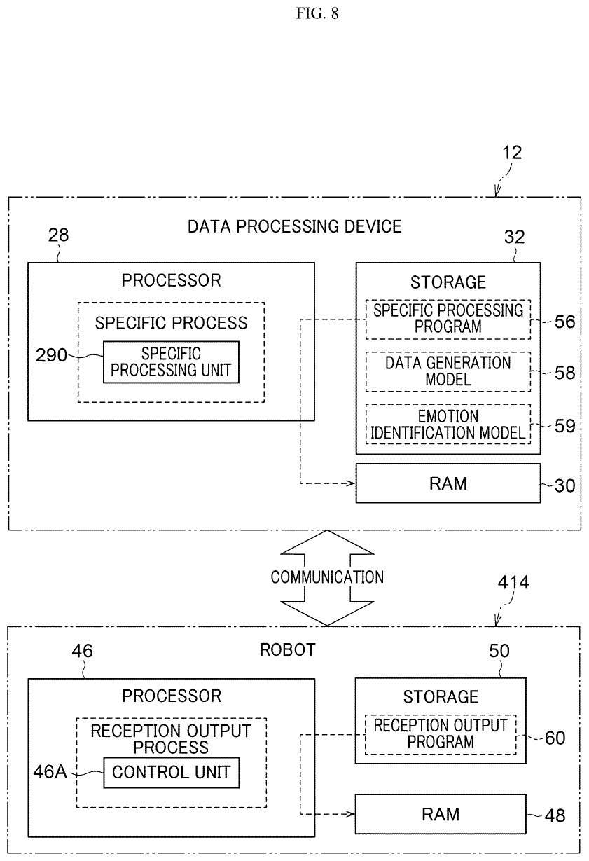

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

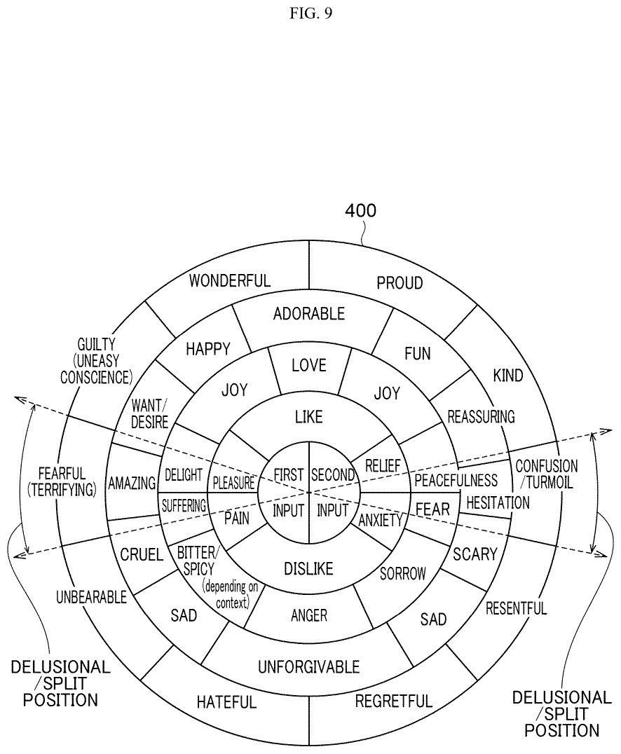

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

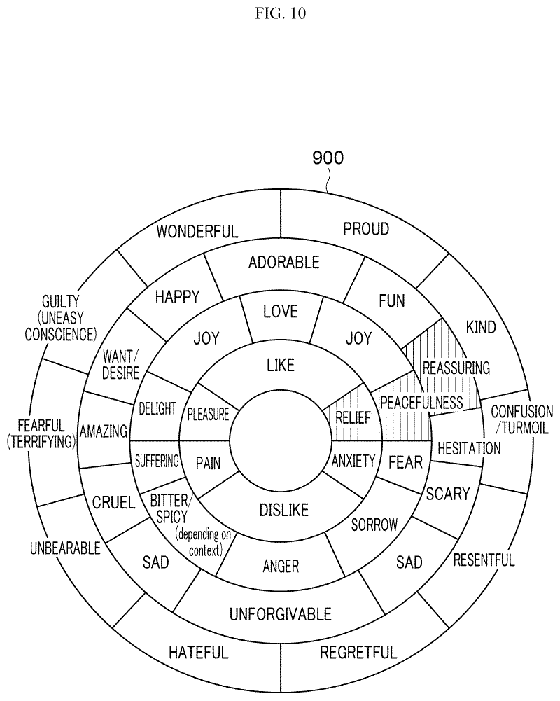

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire merchandise information, analyze the merchandise information based on identification information and attribute information included in the merchandise information, select a generic template according to an analysis result, and generate a sales information display screen by automatically assigning image information and description information to the generic template, by using a prompt sentence for a generative AI model to instruct the generative AI model to perform at least part of the analysis and template selection, and
acquire price information associated with the sales information display screen based on input from a user, record the price information in association with the sales information display screen, and control a publication state of the merchandise information based on the price information, and
receive inquiry information or order information transmitted from a prospective purchaser with respect to the merchandise information in the publication state, generate response candidate information based on contents of the inquiry information and the merchandise information by inputting a prompt sentence including the inquiry information and the merchandise information into the generative AI model, obtain the response candidate information from the generative AI model, present the response candidate information on a seller display screen, and transmit confirmed response information, acquired from the seller display screen, to the prospective purchaser to execute communication processing in a semi-automatic manner, and
acquire transaction information of a merchandise item to be shipped based on the order information, transmit destination information and merchandise attribute information included in the transaction information to a functional interface of an external information processing apparatus for delivery, obtain delivery identification information and delivery identification medium data from the external information processing apparatus for delivery, store the delivery identification medium data in a storage medium, obtain delivery status information from the external information processing apparatus for delivery based on the delivery identification information, and execute delivery processing in a semi-automatic manner by notifying the delivery status information to the seller display screen and a purchaser display screen, and collect evaluation information accumulated in association with the merchandise information, generate a prompt sentence including text data obtained by aggregating the evaluation information, the merchandise information, and the price information, input the prompt sentence into the generative AI model, obtain analysis result information including improvement candidate information for merchandise performance and review candidate information for price setting from the generative AI model, and support merchandise improvement and price review by generating improvement proposal information and price review proposal information for a seller based on the analysis result information and outputting the improvement proposal information and the price review proposal information to a display device.

### (Supplementary 2)

The system according to supplementary 1,
wherein the processor is configured to
acquire text data related to a user, input the text data into an information processing function for emotion state estimation to calculate emotion state information by inputting a prompt sentence including the text data and an emotion estimation condition into the generative AI model or an emotion analysis information processing function, associate the emotion state information with the evaluation information and the merchandise information, analyze the emotion state information in combination with the evaluation information and the merchandise information,
and control presentation of the improvement proposal information and the price review proposal information by modifying the improvement proposal information and the price review proposal information according to the emotion state information.

### (Supplementary 3)

The system according to supplementary 1,
wherein the processor is configured to
automatically extract the identification information and the attribute information included in the merchandise information when the merchandise information is registered, input a prompt sentence including an extraction result into the generative AI model, and automatically generate the sales information display screen based on a template selection result and a component arrangement result output from the generative AI model, and set the sales information display screen into a publishable state without requiring additional editing operations by the user.

### Application Example 1

### (Supplementary 1)

A system comprising a processor,
wherein the processor is configured to
acquire merchandise information including at least identification information, supplement the merchandise information based on the identification information, generate a prompt sentence for a generative information processing model so as to cause natural language generation processing to be performed using the supplemented merchandise information as input information, cause the generative information processing model to generate listing display information including sales information by using the prompt sentence, select display layout information suitable for the merchandise from among a plurality of types of stored display layout information based on the generated listing display information and the supplemented merchandise information, and construct a listing display screen using the selected display layout information,
analyze inquiry information acquired from a purchaser by natural language processing, identify an intention of the inquiry and a related item based on an analysis result and the merchandise information, generate a prompt sentence for instructing the generative information processing model to generate a response sentence using the identified intention and related item as input information, cause the generative information processing model to generate an automatic response sentence by using the prompt sentence, and transmit the automatic response sentence to a purchaser terminal or a seller terminal to execute communication with the purchaser in an automatic or semi-automatic manner,
accumulate evaluation information acquired from a purchaser, perform preprocessing and feature extraction on text data included in the evaluation information by machine learning processing, calculate an emotional tendency and an evaluation tendency for each interest item, generate a prompt sentence for instructing the generative information processing model to create a merchandise improvement proposal and a price adjustment proposal using a calculation result as input information, cause the generative information processing model to generate proposal information including specific merchandise improvement content and price review content by using the prompt sentence, present the proposal information to the seller terminal, and, in response to an approval operation by a seller, update at least one of the merchandise information and price information and reconstruct the listing display screen,
acquire destination information and merchandise information based on transaction information, generate control information for instructing an external delivery service information processing apparatus to execute a delivery procedure and to acquire delivery identification information, automatically generate delivery display information including the delivery identification information, present the delivery display information to the seller terminal, and update delivery status information in response to a confirmation operation by the seller to execute shipping operations in a semi-automatic manner, and
store inquiry information and evaluation information in a time-series manner, analyze the stored information to extract frequently occurring issues and highly evaluated points, generate a prompt sentence for causing the generative information processing model to generate improvement guidelines and price strategy proposals common to a plurality of merchandise items by using an extraction result as input information, cause the generative information processing model to generate strategy proposal information by using the prompt sentence, and collectively display the strategy proposal information on a management display screen.

### (Supplementary 2)

The system according to supplementary 1,
wherein the processor is configured to
preprocess text data acquired from a user by emotion analysis processing, calculate an index value indicating an emotional state, determine a priority of merchandise improvement content and price review content based on the index value and an analysis result of the evaluation information, generate a prompt sentence for instructing the generative information processing model to generate a proposal sentence taking the emotional state into account using the priority and the emotional state as input information, cause the generative information processing model to generate the proposal sentence by using the prompt sentence, and present the generated proposal sentence to the seller terminal as part of the proposal information.

### (Supplementary 3)

The system according to supplementary 1,
wherein the processor is configured to
acquire, as the merchandise information, at least the identification information, automatically acquire merchandise attribute information based on the identification information without requesting additional input, generate a prompt sentence for instructing generation of listing display information using the merchandise attribute information as input information, cause the generative information processing model to generate the listing display information including a description sentence by using the prompt sentence, automatically select appropriate display layout information from among the plurality of types of display layout information based on the merchandise attribute information, and automatically construct the listing display screen using the selected display layout information.

### Example 2

### (Supplementary 1)

A system comprising a processor,
wherein the processor is configured to
acquire product identification information from a terminal and, based on the product identification information, communicate with an external information provision apparatus to acquire product attribute information,
automatically generate listing information data based on the product attribute information, set a price information input region in the listing information data, and construct listing display data, associate and store price information received from the terminal with the listing information data, and generate a sales publication screen,
acquire inquiry information from a prospective purchaser, select response candidate information according to an inquiry type, generate automatic response information, and transmit the automatic response information to the terminal,
acquire delivery identification information and delivery status information, update delivery management information based on the delivery status information, and transmit delivery notification information to a seller and the prospective purchaser, and
acquire evaluation text information stored in an evaluation information storage unit, generate input data including a prompt sentence describing that the evaluation text information is to be summarized and that a product improvement plan and a price adjustment plan are to be generated, provide the input data to a generative information processing model to obtain the product improvement plan and the price adjustment plan, and store and present an output result from the generative information processing model as proposal information for the seller.

### (Supplementary 2)

The system according to supplementary 1,
wherein the processor is configured to
acquire text data input by a user, generate input data including a prompt sentence describing that an emotional state is to be estimated from the text data, provide the input data to an emotion analysis information processing model to obtain emotion evaluation information, and adjust content or a presentation method of the product improvement plan and the price adjustment plan based on the emotion evaluation information.

### (Supplementary 3)

The system according to supplementary 1,
wherein the processor is configured to
when only the product identification information or only the product attribute information is input from the terminal, execute an external information acquisition process based on the product identification information or an analysis process of the product attribute information, automatically select a listing page configuration template according to a template selection rule, and generate listing display data by automatically arranging the product attribute information in the listing page configuration template.

### Application Example 2

### (Supplementary 1)

A system comprising a processor,
wherein the processor is configured to
obtain merchandise information and, in order to automatically generate a sales information page based on the merchandise information, analyze the merchandise information by using a prompt sentence to instruct a generative AI model to perform analysis of the merchandise information and selection of a display-format template, select the display-format template according to a result of the analysis, and arrange generated description information and structural elements in the selected display-format template,
set a desired sale price and reflect the desired sale price in the sales information page, and, in order to perform semi-automatic information exchange with a purchaser based on inquiry information, generate response information by using a prompt sentence to instruct the generative AI model to generate a response sentence in accordance with contents of an inquiry and trade conditions, and output the response information to a communication screen,
perform semi-automatic delivery processing based on delivery information by using a delivery information processing device to obtain delivery identification information and delivery label information, generate guidance information related to the delivery label information by using a prompt sentence to instruct the generative AI model to generate a guidance sentence, output the guidance information, and notify the purchaser of the delivery identification information, obtain evaluation information, analyze descriptive information included in the evaluation information by natural language processing to extract feature information related to characteristics of a merchandise item, generate proposal information by using a prompt sentence to instruct the generative AI model to generate a merchandise improvement proposal and a price revision proposal based on the feature information, and present the proposal information on a seller screen,
obtain conversation information, apply an emotion estimation model to the conversation information to estimate an emotion state, dynamically generate a prompt sentence configured to instruct adjustment of a response manner or proposal contents according to the emotion state, and cause the generative AI model to generate response information or proposal information corresponding to the emotion state by using the prompt sentence, and
record the prompt sentence input to the generative AI model and generated information output from the generative AI model in response to the prompt sentence, and update a configuration of the prompt sentence based on the record so as to continuously optimize at least a part of sales information page generation processing, information exchange processing, delivery guidance processing, and evaluation analysis processing.

### (Supplementary 2)

The system according to supplementary 1,
wherein the processor is configured to
apply the emotion estimation model to at least one of text information, audio information, and image information acquired as user information to estimate the emotion state, add the emotion state as condition information to the prompt sentence to be input to the generative AI model, and adjust communication with the purchaser according to the emotion state by changing at least one of a writing style, a detail level, and presence or absence of an apology expression in the response information in accordance with the emotion state.

### (Supplementary 3)

The system according to supplementary 1,
wherein the processor is configured to
in response to reception of a registration operation for the merchandise information, extract category information and attribute information based on the merchandise information, generate the prompt sentence configured to cause the generative AI model to output only a display-format identifier based on the category information and the attribute information, input the prompt sentence to the generative AI model, automatically select the display-format template based on the display-format identifier output from the generative AI model, and construct the sales information page without requiring additional layout setting operations by automatically placing a merchandise description, feature enumeration information, and price explanation information in the display-format template.

What is claimed is:

1. A system comprising:
circuitry configured to:
receive, via a communication interface coupled to a packet-switched network, item information comprising identification information and attribute information from a terminal device, and store the item information in a storage device;
analyze the item information based on the identification information and the attribute information, select a template according to an analysis result, and generate an information display screen by automatically assigning image information and description information to the template, by generating and supplying a prompt sentence to a generative AI model to perform at least part of the analysis and template selection;
receive configuration parameters associated with the information display screen based on user input, record the configuration parameters in association with the information display screen in the storage device, and control a publication state of the information display screen based on the configuration parameters;
receive inquiry information from a counterpart terminal device via the communication interface, generate response candidate information by inputting a prompt sentence comprising the inquiry information and the item information to the generative AI model, and transmit a selected response to the counterpart terminal device; and
acquire feedback information associated with the information display screen, and generate improvement candidate information by applying a natural language processing model to the feedback information and supplying an analysis result to the generative AI model via a prompt sentence.

2. The system according to claim 1, wherein the circuitry is configured to
analyze text data received from a terminal device using an emotion analysis model to generate an emotional state representation of a user, and incorporate the emotional state representation as a parameter in prompt sentences supplied to the generative AI model to generate emotion-adjusted improvement candidate information.

3. The system according to claim 2, wherein the circuitry is configured to
apply a sentiment classification model to the feedback information to classify each feedback item into a positive, neutral, or negative sentiment category, and weight improvement candidate information based on the sentiment classification results.

4. The system according to claim 3, wherein the circuitry is configured to
generate updated configuration parameters based on the improvement candidate information and transmit the updated configuration parameters to the terminal device for user review prior to application.

5. The system according to claim 4, wherein the circuitry is configured to
apply a price adjustment recommendation model to configuration parameters stored in the storage device and the improvement candidate information, and generate configuration parameter adjustment recommendations as part of the improvement candidate information.

6. The system according to claim 1, wherein the circuitry is configured to
apply a named entity recognition model to the item information to extract category labels and attribute descriptors, and use the extracted category labels and attribute descriptors to select the template from a predefined template library stored in the storage device.

7. The system according to claim 6, wherein the circuitry is configured to
apply a layout optimization model to the selected template and the image information to determine positioning and sizing parameters for each element of the information display screen, and incorporate the positioning and sizing parameters into the prompt sentence supplied to the generative AI model.

8. The system according to claim 1, wherein the circuitry is configured to
receive order information from the counterpart terminal device via the communication interface, extract transaction condition parameters from the order information, and generate a processing instruction prompt for the generative AI model based on the transaction condition parameters and the item information.

9. The system according to claim 8, wherein the circuitry is configured to
apply a workflow automation model to the processing instruction prompt response to generate a sequence of operations for fulfillment of the order information, and transmit operation instructions to connected processing units via the communication interface.

10. The system according to claim 1, wherein the circuitry is configured to
aggregate feedback information from a plurality of counterpart terminal devices, apply a topic modeling algorithm to the aggregated feedback information to extract recurring issue categories, and incorporate the recurring issue categories as structured parameters in the prompt sentence for improvement candidate generation.

11. The system according to claim 10, wherein the circuitry is configured to
apply a frequency analysis model to the recurring issue categories to rank categories by occurrence count, and prioritize improvement candidate information corresponding to highest-ranked categories.

12. The system according to claim 1, wherein the circuitry is configured to
apply a multimodal analysis model to image information associated with the item information to generate a visual feature description, and incorporate the visual feature description as an additional input in the prompt sentence supplied to the generative AI model for description generation.

13. The system according to claim 12, wherein the circuitry is configured to
apply a convolutional neural network to the image information to extract visual feature vectors, and use the visual feature vectors to identify a best-matching template from the predefined template library.

14. The system according to claim 1, wherein the circuitry is configured to
apply a similarity matching model to the inquiry information received from the counterpart terminal device to identify semantically similar prior inquiry records stored in the storage device, and include matching prior inquiry records and corresponding response records in the prompt sentence for response candidate generation.

15. The system according to claim 14, wherein the circuitry is configured to
apply a ranking model to the response candidate information to score each response candidate based on relevance to the inquiry information and consistency with item information stored in the storage device, and present highest-scoring response candidates to the user via the terminal device.

16. The system according to claim 1, wherein the circuitry is configured to
monitor a performance metric associated with the information display screen based on interaction data received from terminal devices, and generate an alert prompt sentence for the generative AI model when the performance metric falls below a predetermined threshold.

17. The system according to claim 16, wherein the circuitry is configured to
generate revised description information and updated configuration parameters based on the alert prompt sentence response from the generative AI model, and apply the revised description information to update the information display screen.

18. A system comprising:
circuitry configured to:
receive, via a communication interface coupled to a packet-switched network, item information comprising identification information and attribute information from a terminal device, apply a named entity recognition model to extract category labels and attribute descriptors, and select a template from a predefined template library based on the extracted category labels;
generate an information display screen by assigning image information and description information to the selected template using a prompt sentence supplied to a generative AI model, receive configuration parameters from the terminal device, and store the configuration parameters in association with the information display screen;
receive inquiry information from a counterpart terminal device, apply a similarity matching model to identify prior inquiry records, generate response candidate information by supplying a prompt sentence comprising the inquiry information and matching prior records to the generative AI model, and transmit a selected response to the counterpart terminal device;
receive feedback information from counterpart terminal devices, apply a topic modeling algorithm to extract recurring issue categories, and generate improvement candidate information by supplying a prompt sentence incorporating ranked issue categories to the generative AI model; and
analyze text data using an emotion analysis model to generate an emotional state representation, and incorporate the emotional state representation as a parameter in prompt sentences for emotion-adjusted improvement candidate generation.

19. The system according to claim 18, wherein the circuitry is configured to
apply a price adjustment recommendation model to configuration parameters and improvement candidate information, generate configuration parameter adjustment recommendations, and transmit the adjustment recommendations to the terminal device for user review.

20. A method comprising:
receiving, via a communication interface coupled to a packet-switched network, item information comprising identification information and attribute information from a terminal device, and storing the item information in a storage device;
analyzing the item information based on the identification information and the attribute information, selecting a template according to an analysis result, and generating an information display screen by automatically assigning image information and description information to the template, by generating and supplying a prompt sentence to a generative AI model to perform at least part of the analysis and template selection;
receiving configuration parameters associated with the information display screen based on user input, recording the configuration parameters in association with the information display screen in the storage device, and controlling a publication state of the information display screen based on the configuration parameters;
receiving inquiry information from a counterpart terminal device via the communication interface, generating response candidate information by inputting a prompt sentence comprising the inquiry information and the item information to the generative AI model, and transmitting a selected response to the counterpart terminal device; and
acquiring feedback information associated with the information display screen, and generating improvement candidate information by applying a natural language processing model to the feedback information and supplying an analysis result to the generative AI model via a prompt sentence.
